(19) United States
(12) Patent Application Publication
(10) Pub. No.: US 2012/0150598 A1
(43) Pub. Date: Jun. 14, 2012

(54) SOCIAL RETAIL REFERRAL CONTROL APPARATUSES, METHODS AND SYSTEMS

(76) Inventor: Alfred William Griggs, Menlo Park, CA (US)

(21) Appl. No.: 13/225,264

(22) Filed: Sep. 2, 2011

Related U.S. Application Data
(60) Provisional application No. 61/379,720, filed on Sep. 2, 2010.

(51) Int. Cl. G06Q 30/02

(52) U.S. Cl. 705/14.16

(57) ABSTRACT

The SOCIAL-REF transforms user submission of a share item and/or via SOCIAL-REF components into referral fee payments. In one embodiment, a method is disclosed, including: receiving a share item via a share channel from a user; determining a share target for the received share item based on share item characteristics and user specified sharing criteria; generating a share message including the share item in accordance with the user specified sharing criteria; distributing the share message via the share channel to the share target; tracking the share target activity usage; determining, a referral reward to the user based on the tracked share target activity usage; and facilitating a payment of the determined referral reward from an associated sponsor to the user.

### RELATED APPLICATIONS

Applicant hereby claims priority under 35 USC §119 for U.S. provisional patent application Ser. No. 61/379,720, filed Sep. 2, 2010, entitled “Apparatuses, Methods and Systems for a Social Retail Platform,” attorney docket no. P-41627PRV|20270-015PV.

The instant application is related to Patent Cooperation Treaty international application serial no. PCT/US11/50424, filed Sep. 2, 2011, entitled “Social Retail Referral Control Apparatuses, Methods And Systems” (attorney docket number P-41627WO120270-015PC).

### FIELD

The present invention is directed generally to an apparatuses, methods, and systems of e-commerce, and more particularly, to SOCIAL RETAIL REFERRAL CONTROL APPARATUSES, METHODS AND SYSTEMS.

### BACKGROUND

The Internet allows users to transmit and receive information with other users and entities. Some retailers use the Internet to provide web pages representing online stores. Using the Internet, consumers may access such online stores to make purchases.

### BRIEF DESCRIPTION OF THE DRAWINGS

The accompanying appendices and/or drawings illustrate various non-limiting, example, inventive aspects in accordance with the present disclosure:

FIGS. 1A and 1B are block diagrams illustrating examples of the SOCIAL-REF publications and referral fee payment within embodiments of the SOCIAL-REF;

FIGS. 1C and 1D are of block diagrams illustrating the SOCIAL-REF data flows between SOCIAL-REF platform and its affiliated entities within one embodiment of the SOCIAL-REF;

FIGS. 2A-2C, 3 and 4 are logic flow diagrams illustrating SOCIAL-REF work flows in an embodiment of the SOCIAL-REF;

FIGS. 5A-5C are exemplary schematic screen shots illustrating SOCIAL-REF user interfaces in an embodiment of the SOCIAL-REF;

FIGS. 6A-F show application user interface diagrams illustrating example features of a snap mobile payment app for capturing product barcodes, securing user data and preventing fraud in some embodiments of the SOCIAL-REF;

FIGS. 7A-D show data flow diagrams illustrating an example snap mobile payment procedure in some embodiments of the SOCIAL-REF;

FIGS. 8A-E show logic flow diagrams illustrating example aspects of executing a snap mobile payment in some embodiments of the SOCIAL-REF; and

FIG. 9 is of a block diagram illustrating embodiments of the SOCIAL-REF controller.

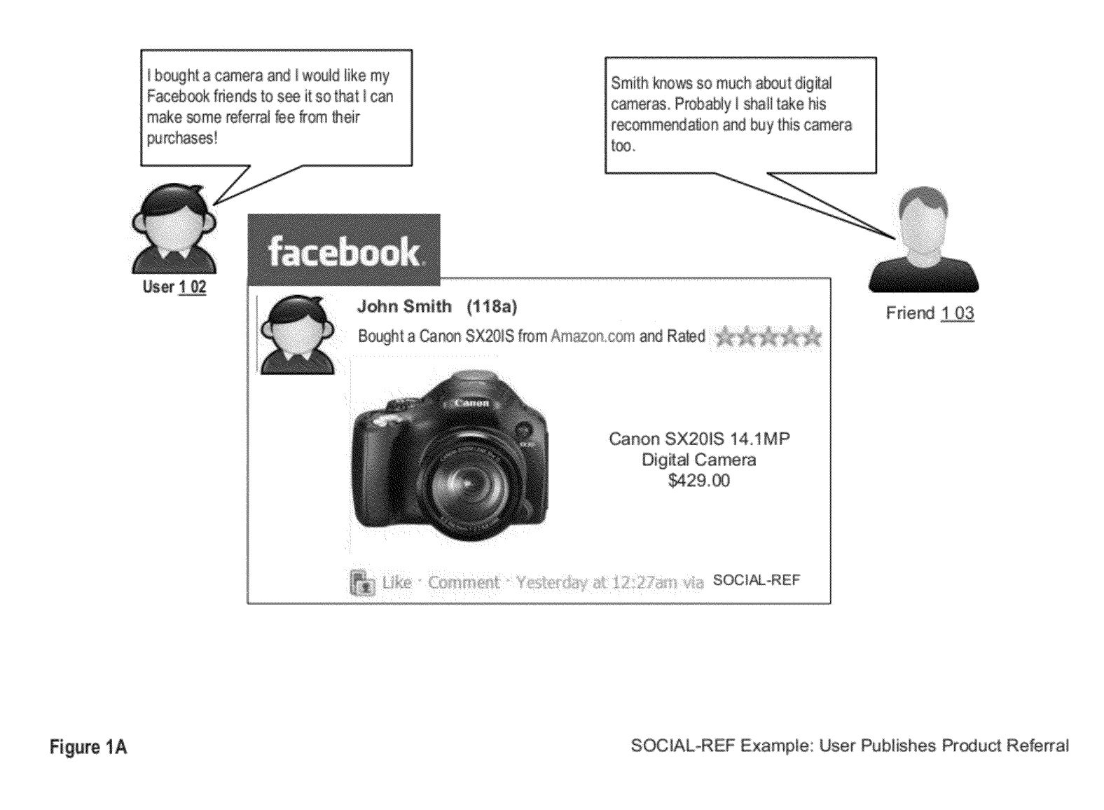

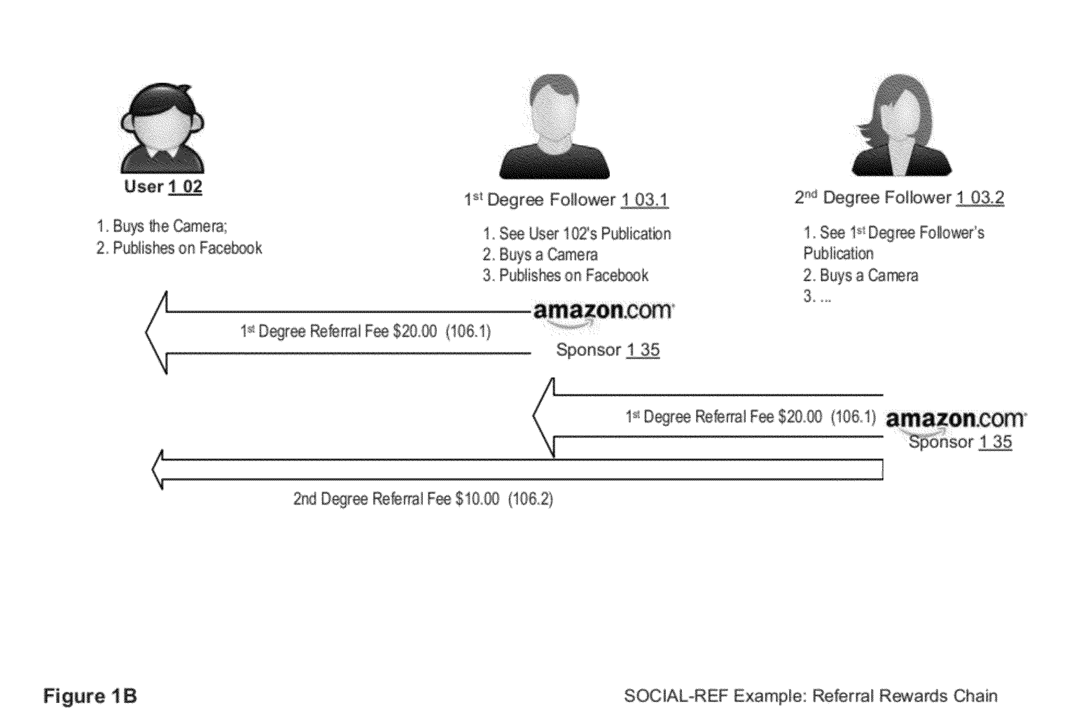

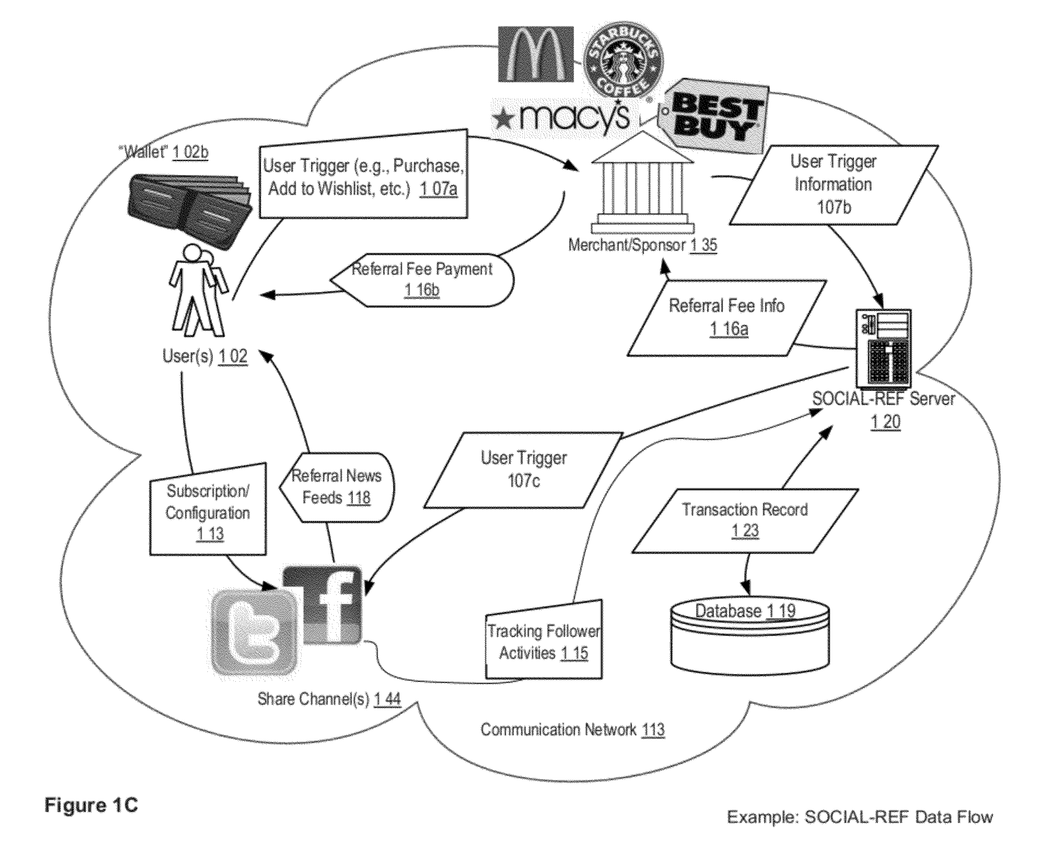

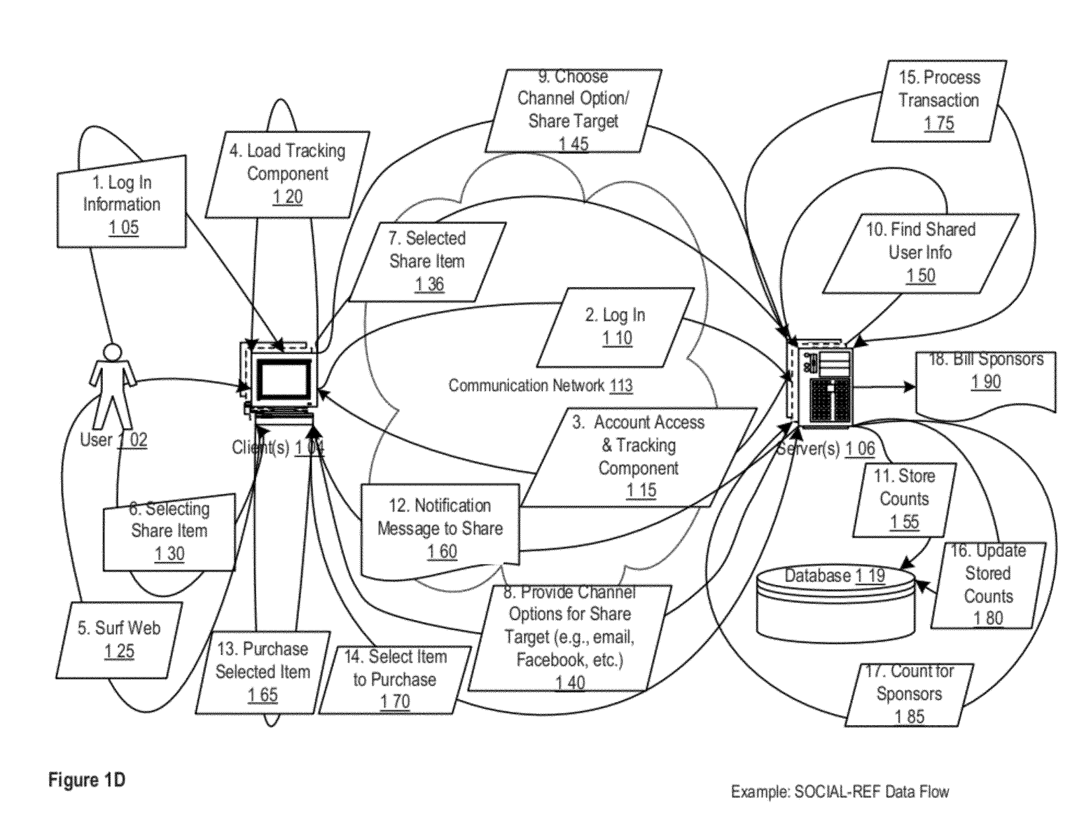

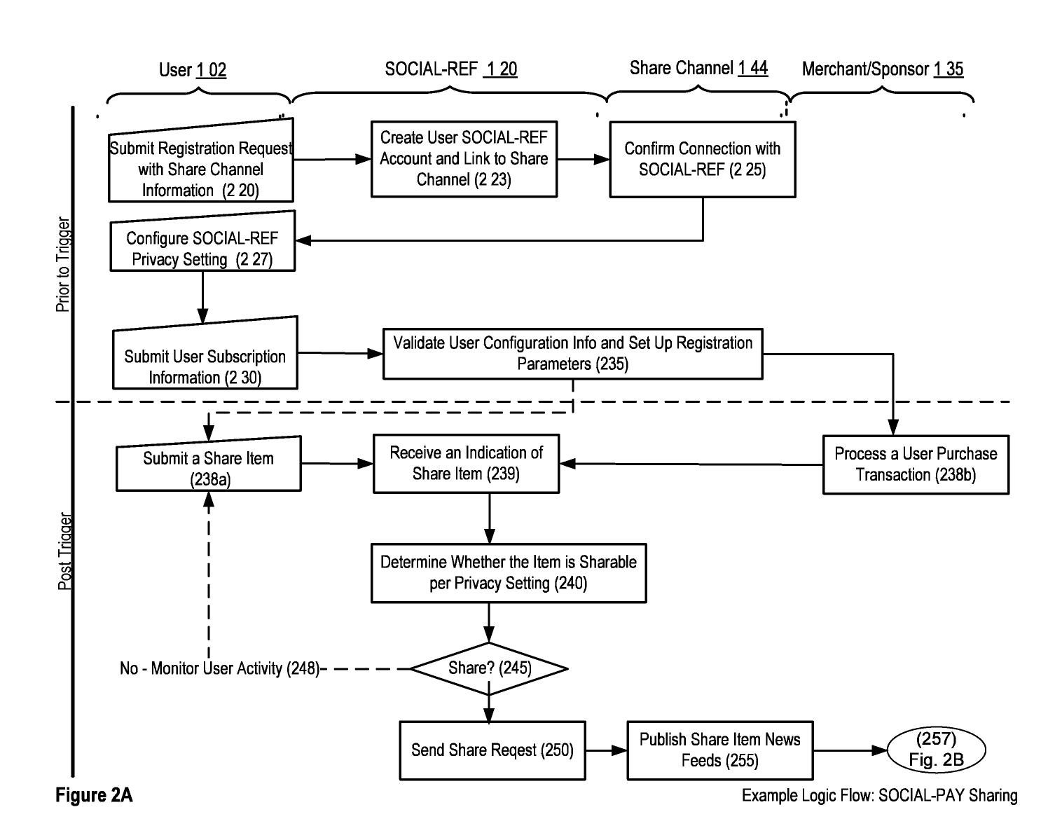

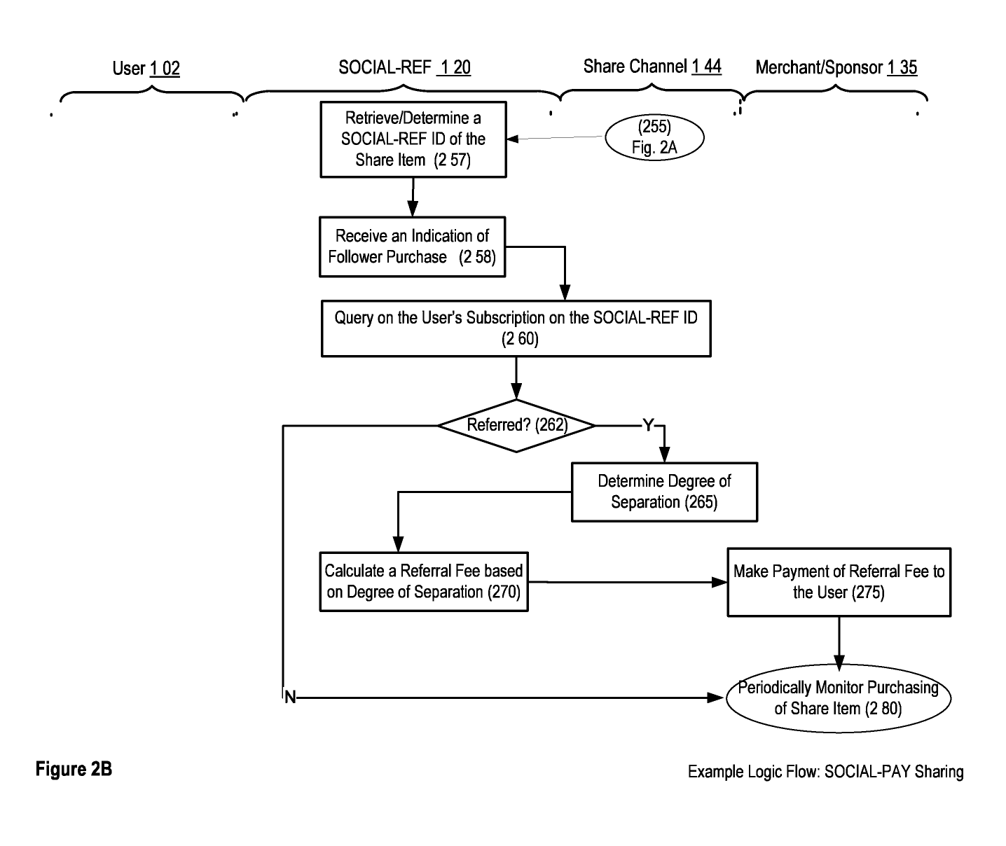

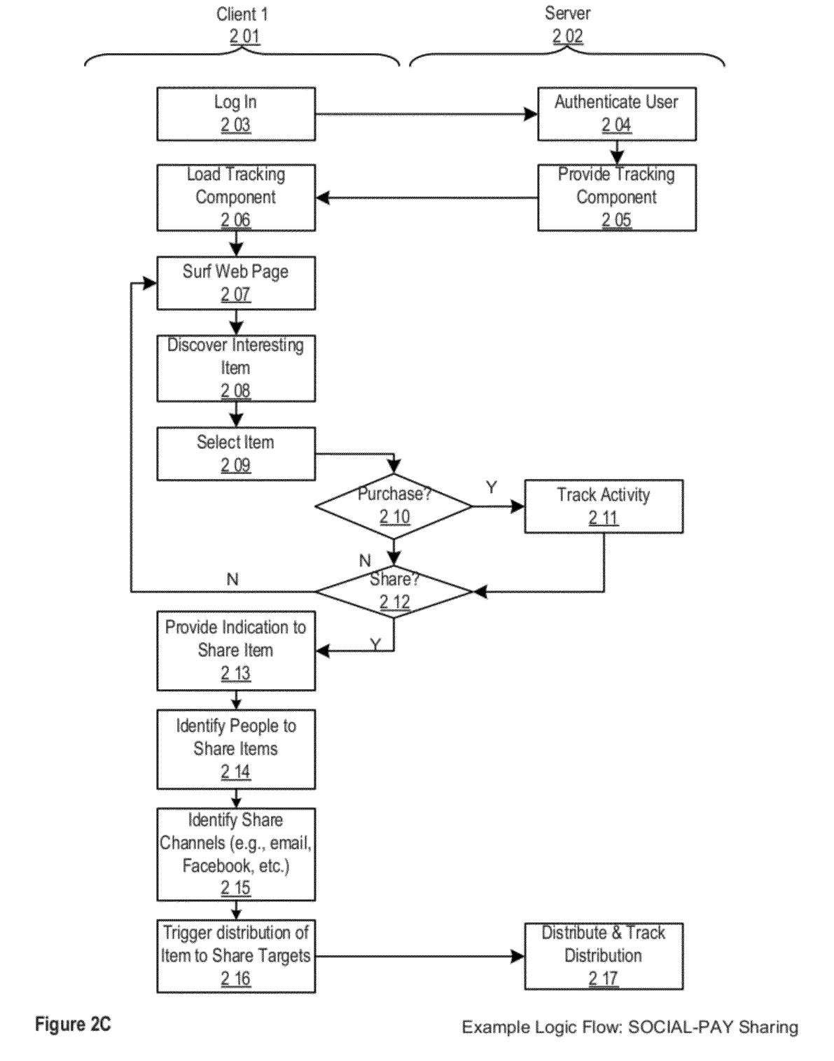

The leading number of each reference number within the drawings indicates the figure in which that reference number is introduced and/or detailed. As 101 would be found and/or introduced in FIG. 1. Reference number 201 is introduced in FIG. 2, etc.

### DETAILED DESCRIPTION

The SOCIAL RETAIL REFERRAL CONTROL APPARATUSES, METHODS AND SYSTEMS (hereinafter “SOCIAL-REF”) may provide a social purchasing information sharing platform which allows a user to publish and control access of followers to his purchasing history such that the user may receive a referral fee based on a referral chain of followers' purchasing.

For example, in one implementation, a user may elect to publish his online shopping history on a social platform (e.g., Facebook post, Tweet, etc.), wherein his followers on the social platform may see his new purchasing and may be interested in purchasing such products. In one implementation, the user's direct followers may purchase the product, and in turn publish the purchase on the follower's social platform page. As such, SOCIAL-REF may maintain a chain of social sharing of purchasing history, and may return a referral fee to the original user based on the degree of separation on the referral chain. In one implementation, the user may control access of his followers to view his purchasing history. For example, the user may categorize his purchase and only allow followers to access purchasing history within one or more selected categories, e.g., “electronics,” “beauty,” etc. For another example, the user's follower may subscribe to the user's purchasing history and configure the subscription based on category, e.g., a follower may only elect to subscribe to the user's purchasing news in the category “electronics,” etc.

Within embodiments, SOCIAL-REF may transform a user share item selection via distribution, consumption, and usage components into log in messages, channel options for share target messages, notification of shares messages, store counts, counts for sponsors, and bills for fees due from sponsors. Within embodiments, a user may select an item to share (“share item”), people or entities with whom the user would like to share the share item (“share target(s)”) and a means or mechanism by which to share the share item(s) (“share channel(s)”), e.g., email, social networking Web sites, etc. In an embodiment, the share item(s) may be found on sponsor, merchant, advertiser, and/or the like (“sponsor”) Web site. Depending on the implementation, the tools to identify/select an item may be implemented by the Web site (e.g., using a component or tool of the SOCIAL-REF) and/or implemented on a user's computer or browser application. The SOCIAL-REF and/or a related or associated server may receive this information from a client (e.g., the user's machine and/or browser), and distribute the share item(s) information to the share target(s) via the share channel(s). The server may track this process, counting the number of share targets for each share item, and monitoring the share channels used in each case. In an embodiment, the server may also track other information, such as the number of times the share item is purchased and who purchased it, i.e., the original user, the user's selected share targets, or the share targets' share targets. These counts (“share counts”) may be generated by the server and stored in various database(s), and may be tallied to determine the fees each sponsor owes. The server may then generate a bill and charge the sponsor(s) based on the share counts.

Within embodiments, the SOCIAL-REF may facilitate and enable enhanced retail interactions and transactions. In one embodiment, the SOCIAL-REF provides and/or utilizes a tracker component or element that collects social and retail interaction information. For example, in one implementation, using a tracker component in communication with a server, the SOCIAL-REF may monitor a particular user's interests in one or more products and communications and/or actions related to the product(s). In one embodiment, features of the SOCIAL-REF allow users to save products found during online shopping in a centralized database where a user can view the item at a later date, purchase the item, share it with another user, post it to a social networking Web site, etc. Such actions may be tracked and/or stored by the SOCIAL-REF. In some implementations, merchants (and/or other interested entities) utilizing the SOCIAL-REF may be assessed an affiliate fee when these products are purchased via this centralized online shopping database. The SOCIAL-REF may track how often an item or product is shared, the means by which it was shared, and/or the number of purchases of the item (e.g., as a result of the sharing).

In some implementations, the SOCIAL-REF may determine a fee (e.g., a referral fee) based on the collected information. For example, in one implementation, a referral fee may vary based on how many of degrees of sharing have occurred between the original user and an eventual purchaser and/or subsequent sharer. In one embodiment, the fee may grow as more people share and/or purchase the item. In one implementation, the SOCIAL-REF may determine a certain fee if a user shares an item with a friend, and determine a larger fee if the user posts the item to a social networking site, where sharing could increase drastically and the item may be viewed by more people. In some implementations, a user's interactions (e.g., sharing) may be tracked by altering a product hyperlink with a tracking link or code that records each time the product is shared.

Within implementations, the SOCIAL-REF facilitates, enhances, enables, creates, generates, and/or provides (“provides”) enhanced retail interactions, transactions, advertising, monetization, data collection, data management and/or analysis, communications, and/or marketing relating to online user/consumer (“user”) behaviors and interests.

In one embodiment, the SOCIAL-REF enhances the way users browse and compare products, initiate and/or complete online transactions, and/or interact with other users and/or entities (e.g., online retailers). In some embodiments, the SOCIAL-REF may provide a user account and/or profile that includes user generated and/or specified information/content. In one such implementation, the profile may include a “wish list” that reflects a user's interests, including but not limited to a listing of products, services, and/or the like (“items”) that the user is interested in (e.g., pictures and/or titles of products the user is considering purchasing and/or wants to receive). Depending on the implementation, the distribution/accessibility of the wish list and/or elements thereof may be determined by a user, a service provider (e.g., an entity implementing the SOCIAL-REF and/or components thereof), a retailer, and/or the like. For example, in one implementation, a user may specify that certain items on the wish list can be viewed by and/or shared with anyone who also has an account/profile, while specifying that other items on his or her wish list may only be viewed by and/or shared with friends (e.g., as defined by a “friends list”, social network information (e.g., Facebook®, LinkedIn®, etc.). Another embodiment may make items a user has added to a wish list viewable to others as a way of sharing the information.

Other embodiments of the SOCIAL-REF may provide enhanced online browsing/shopping, evaluations, allow users to solicit opinions/advices from friends and/or other users, allow retailers/marketers to provide targeted offers reflecting a user's interests, and/or provide enhanced/streamlined transactions/purchases (e.g., provided expedited completion of forms and/or payment). One such embodiment may utilize user-targeted advertising or may provide special offers and/or incentives for a certain number of shares and/or purchases.

### SOCIAL-REF

FIGS. 1A and 1B provide examples illustrating a SOCIAL-REF users interaction and referral payment within implementations of the SOCIAL-REF. As shown in FIG. 1A, a user 102 may make a purchase of a product, e.g., a digital camera, and may want to share the purchase with his friends. For example, a user may publish a Facebook message (e.g., 118a) so that his friends may see the post from their Facebook news feeds. The Facebook message 118a may indicate the user “John Smith” just bought a “Canon SX20IS from Amazon.com” and show the user “John Smith” gives a five star review of the purchased camera. In one implementation, the user may manually generate the Facebook message 118a, e.g., by updating his Facebook status. In another implementation, the user may register with a SOCIAL-REF electronic wallet service, which may automatically populate the user's purchasing activities to Facebook.

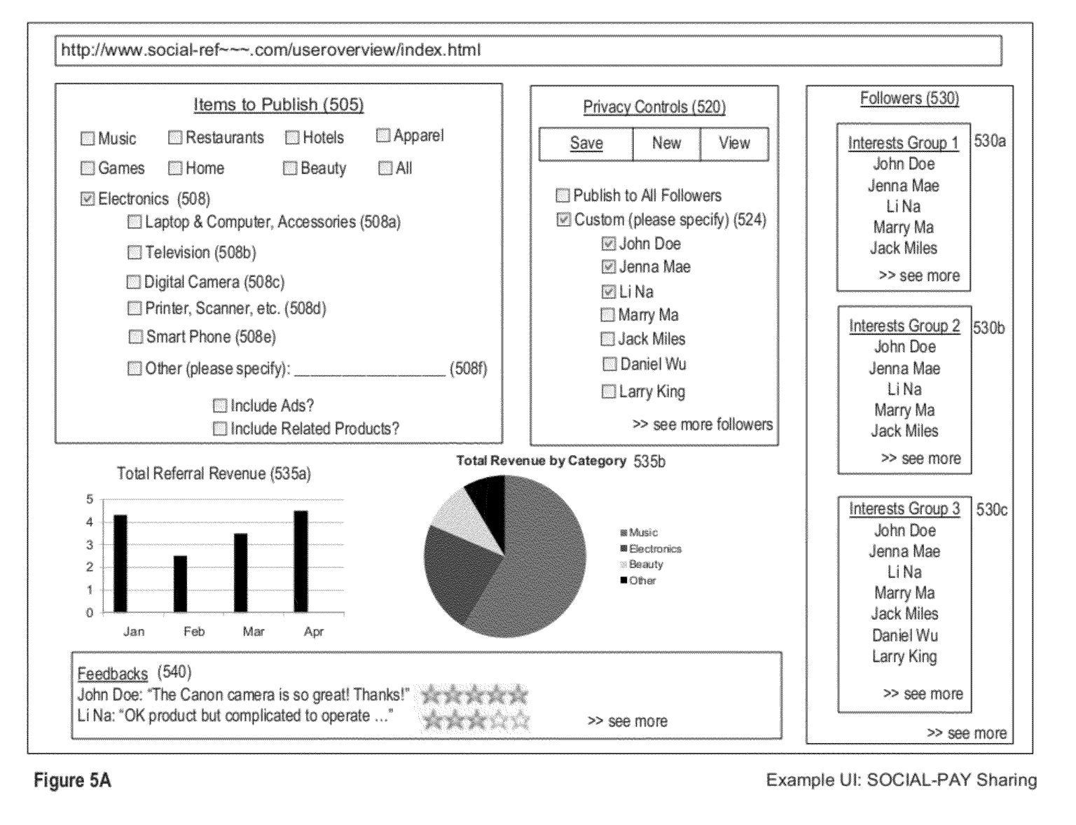

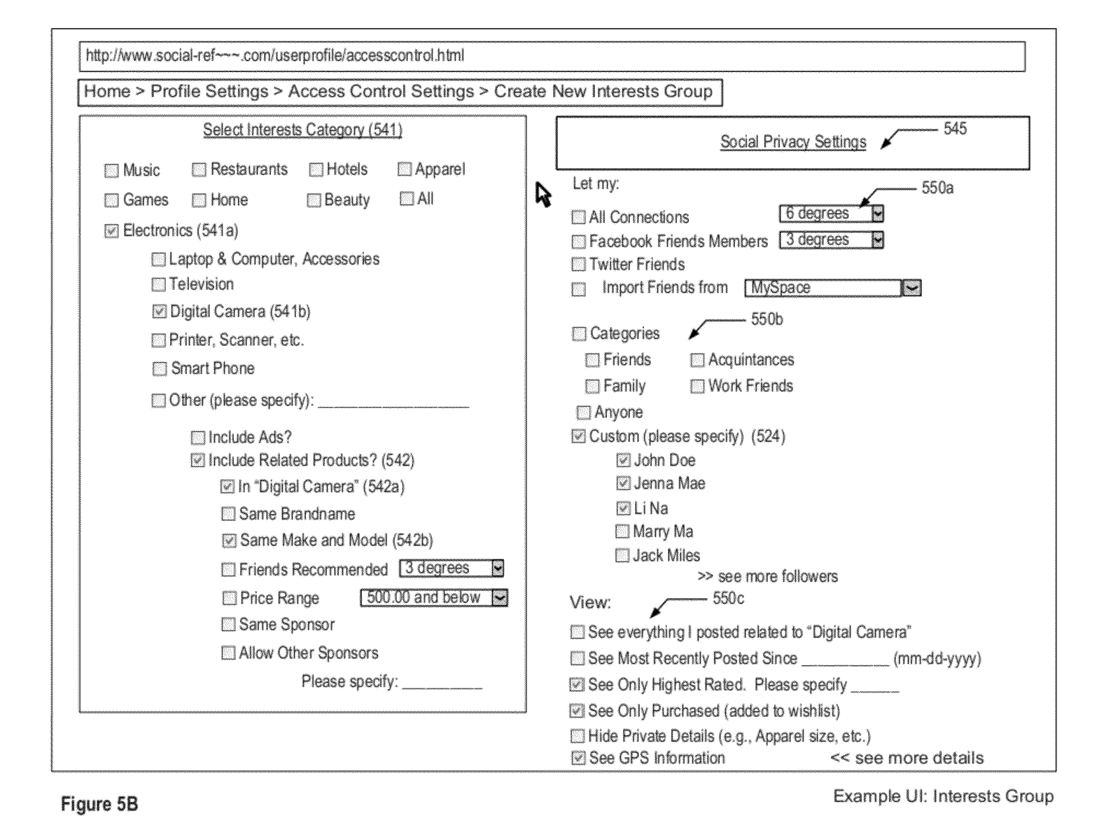

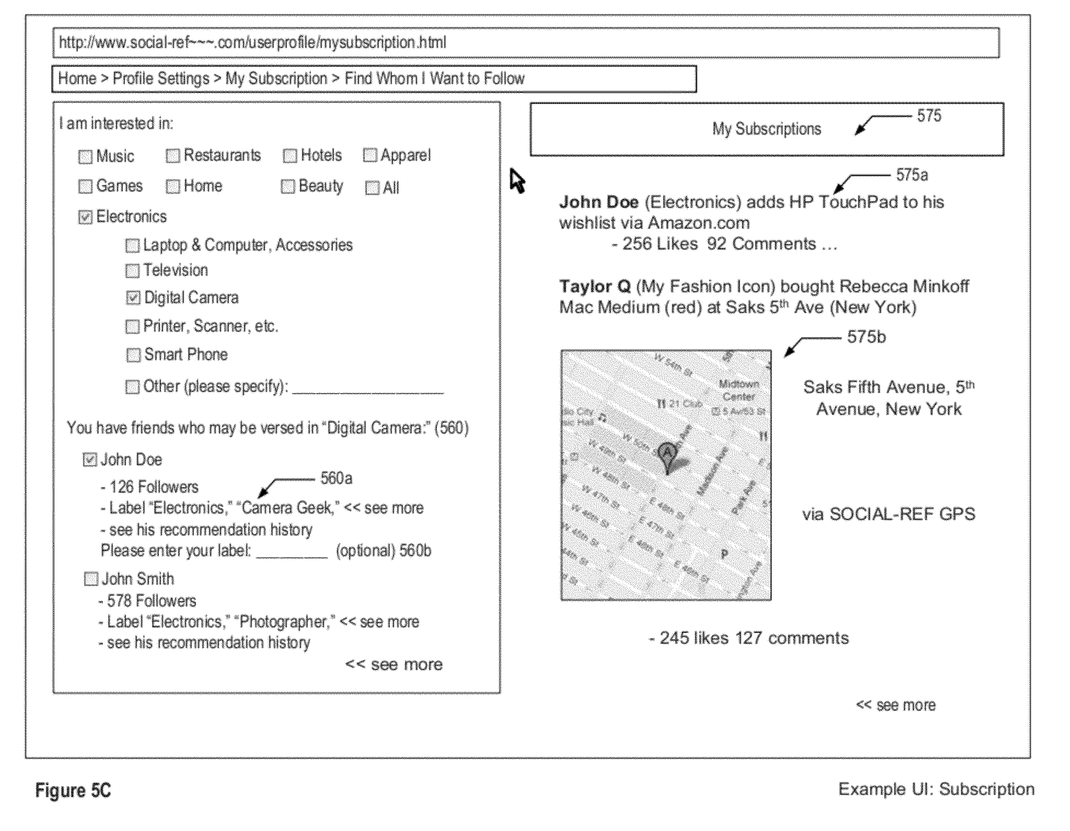

Within different implementations, the user may opt to share his purchasing message 118a via a variety of share channels, e.g., mobile messages, emails, Twitter, instant messenger, and/or the like (e.g., see at least FIG. 2C). Within other implementations, the user may opt to configure access of his social contacts to see his purchasing news 118a, content of the message, and/or the like. For example, the user may configure that only a selected group of his Facebook friends are permitted to view his SOCIAL-REF news feed (e.g., 118a), as further illustrated in FIGS. 5A-5B.

In one implementation, the user's follower 103, e.g., a friend whom “John Smith” has allowed access to view “John Smith's” SOCIAL-REF news feeds, etc., may receive the SOCIAL-REF message 118a. As the friend 103 may follow the user 102 (e.g., “John Smith”) as a “photography expert,” which may be a customized label assigned by the friend 103 (e.g., see at least FIG. 5C), the friend 103 may find “John Smith's” purchasing and 5 start rating of the “Canon SX20IS” camera a good reason for him to purchase the same camera as well. As such, the user 102 may refer his friend 103 to purchase the product by publishing his purchasing news on Facebook.

FIG. 1B shows an example of a SOCIAL-REF referral chain within implementations of the SOCIAL-REF. As in the example illustrated in FIG. 1A, the user “John Smith” 102 may have bought a “Canon SX20IS” camera from “Amazon.com,” and such purchasing information is posted on his Facebook page. The user's friend, which may be a direct, or a first degree contact of “John Smith” 103.1 (e.g., an individual who is in the friends list of “John Smith”) may see the user's Facebook post (e.g., 118a in FIG. 1A) with regard to the “Canon SX20IS,” and may elect to purchase the same camera as well. In one implementation, the first degree follower's 103.1 purchase may lead to a referral reward to the user 102. For example, a SOCIAL-REF sponsor 135 (e.g., the merchant site “Amazon.com,” the brand name company, the distributor, and/or the like) may reward a first degree referral fee 106.1, e.g., $20.00, to the user 102, for publishing his purchasing information to the first degree follower.

In one implementation, when the first degree follower 103.1 purchases the camera and may publish his own purchasing information on Facebook, a second degree follower 103.2 of the user 102 (e.g., a Facebook friend of the first degree follower 103.1) may view the first degree follower's 103.1 publication with regard to the camera purchase. When the second degree follower 103.2 elects to purchase the camera after viewing the first degree follower's publication (e.g., Facebook post, etc.), the sponsor 135 may determine referral fee payment along the referral chain, e.g., the indirect/two degree of separation referral from the user 102 to the first degree follower 103.1, and then to the second degree follower 103.2, etc. For example, the sponsor may award a first degree referral fee 106.1, e.g., $20.00, etc., to the first degree follower. For another example, the sponsor may award the user 102 for a second degree referral fee 106.2, e.g., $10.00, etc., from the second degree follower's purchase.

Within implementations, the sponsor 135 may specify the maximum degree of followers' activities that may trigger a referral reward to the originator (e.g., the user 102 in this example). For example, when the sponsor specifies the maximum degree that triggers referral fee is two, when a follower of the second degree follower 103.2 (e.g., a Facebook friend of the second degree follower 103.2) buys the camera after viewing the second degree follower's 103.2 purchase, the user 102 may not be awarded for referral as they are more than two degrees apart.

FIG. 1C shows a block diagram illustrating data flows between SOCIAL-REF server and affiliated entities within various embodiments of the SOCIAL-REF. Within various embodiments, one or more consumers user(s) 102, SOCIAL-REF server 120, SOCIAL-REF database(s) 119, merchant and/or sponsors 135, share channel(s) 1444 and/or the like are shown to interact via various communication network 113.

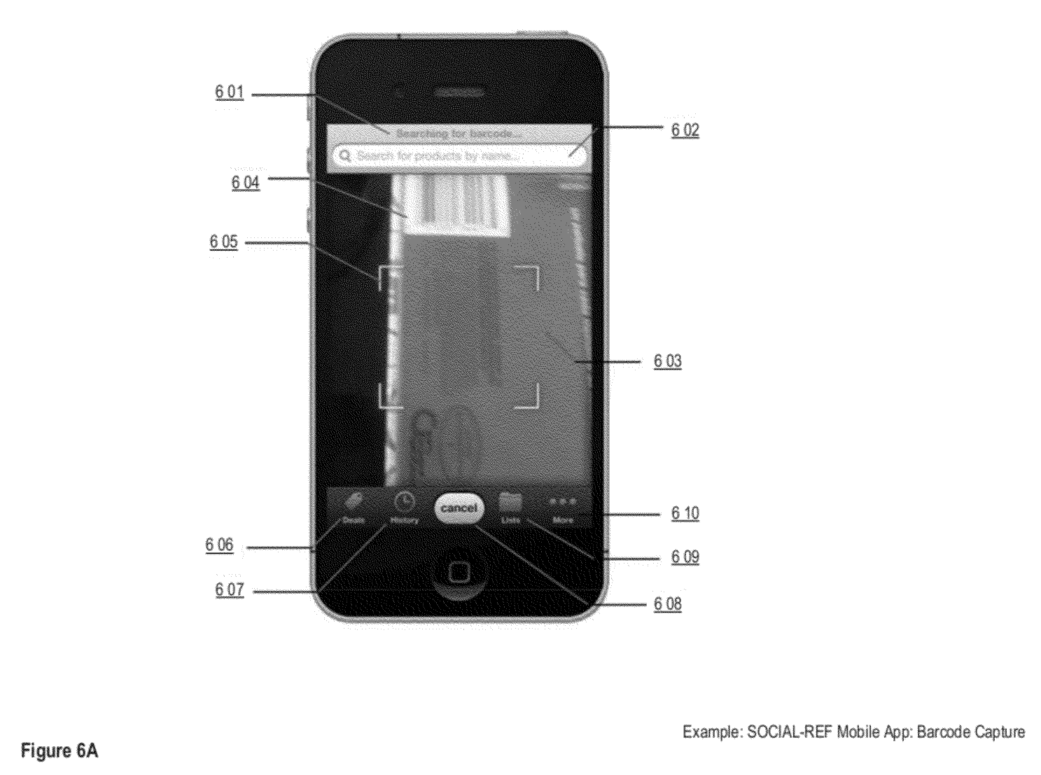

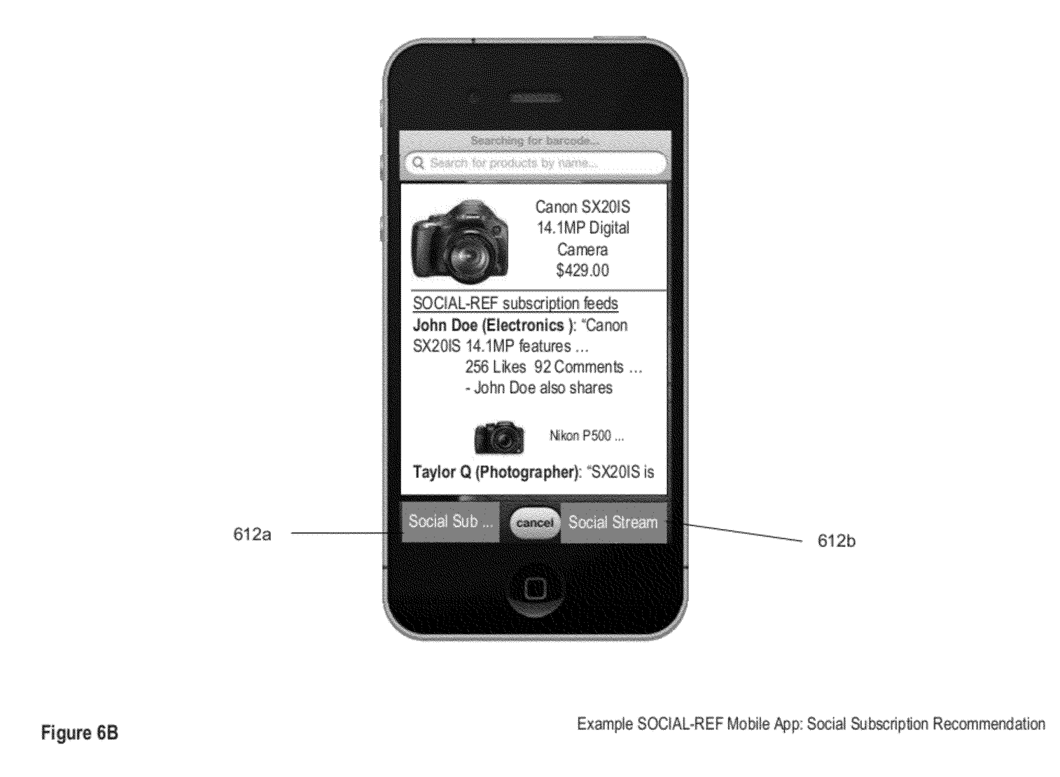

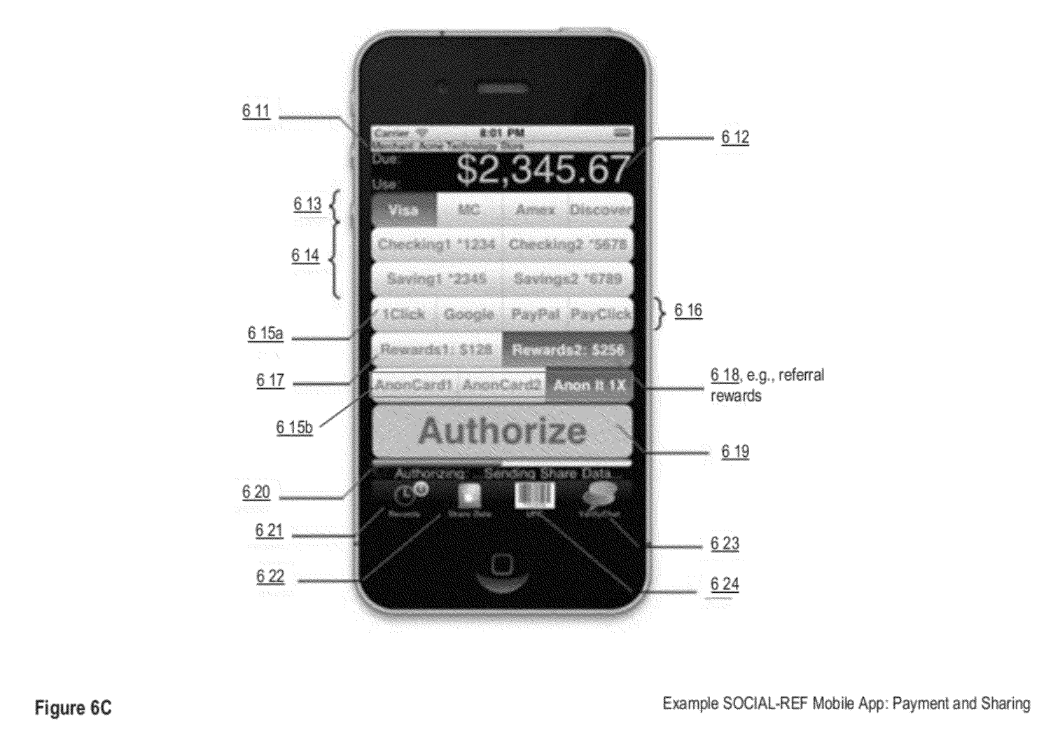

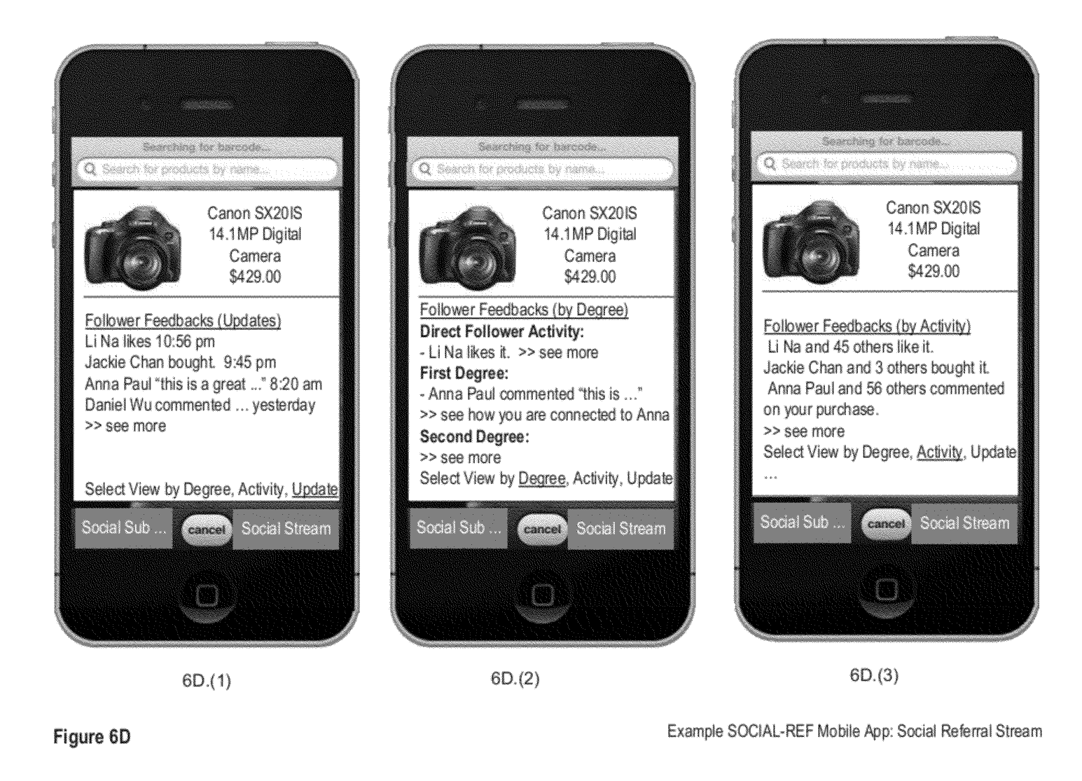

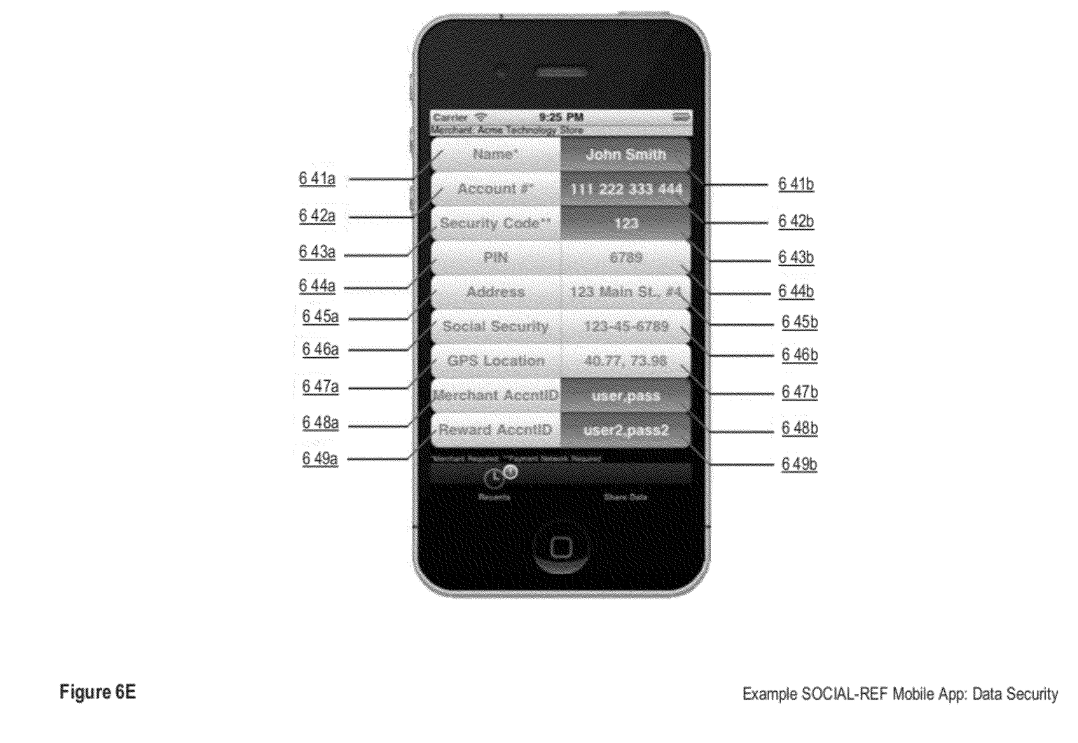

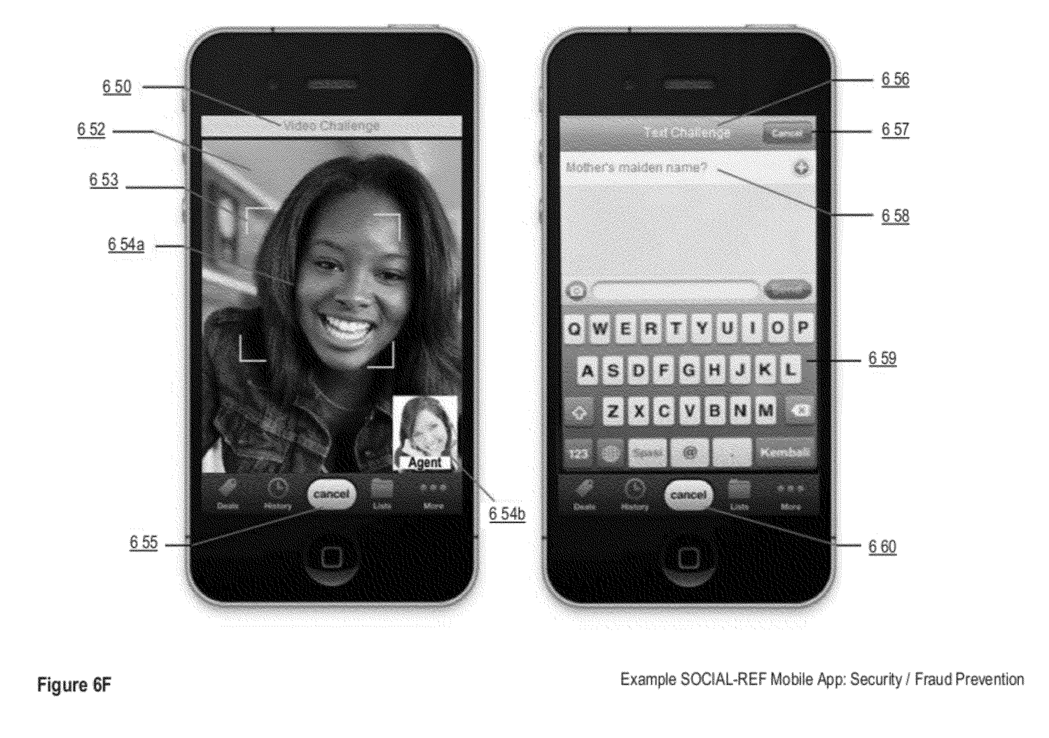

In one embodiment, a user 102, may be associated with an electronic wallet 102b (e.g., a Visa V-Wallet, etc.), which may comprise one or more of a bank account, a SOCIAL-REF service account, a merchant membership account, and/or the like, possessed with the user 102. For example, a consumer may possess an electronic wallet linked a Bank of America checking account, a Chase credit card account, a Sam's Club membership account, and/or the like. For another example, the consumer's electronic wallet may be registered for the SOCIAL-REF service. In one implementation, the electronic wallet 102b may comprise a variety of vehicles, e.g., a bank card, a mobile component instantiated on a mobile device, etc. In one implementation, a SOCIAL-REF electronic wallet mobile component is further discussed in FIGS. 6A-6F.

In one embodiment, upon registering with SOCIAL-REF, the user 102 may provide a user trigger 107 to the merchant/sponsor 135. For example, the user 102 may add an item to his wishlist on a merchant site, “like” an item on the merchant site, make a purchase of an item on the merchant site, and/or the like. For another example, the user 102 may trigger SOCIAL-REF by buying an item at a physical merchant store, wherein the GPS information of such physical merchant store may be included in the User Trigger. For example, if the user purchases a share item at a physical store, the merchant store 135 may obtain the “wallet” information 102b at its POS terminal, which may comprise the user's wallet account information (e.g., a wallet ID, the associated bank information, etc.), the product reservation information, and/or the like. The merchant store may then pass on the purchasing information including generate a merchant store/terminal identification information, consumer wallet identification information, a payment amount, and/or the like to the SOCIAL-REF server 120.

In one implementation, the merchant 135 may comprise any of a merchant site (e.g., BestBuy.com, Amazon.com, etc.), a merchant store (e.g., Macy's, Starbucks Coffee, etc.), and/or the like. In one implementation, the merchant 135 may sponsor SOCIAL-REF referral rewards. In another implementation, the sponsor 135 may comprise any of a manufacturer, distributor, retailer, and/or the like.

In one implementation, the merchant 135 may pass the user trigger information 107b to the SOCIAL-REF server 120, wherein the SOCIAL-REF server 120 may create a unique identifier of the related item for activity tracking. For example, the merchant 135 may provide a (Secure) Hypertext Transfer Protocol (“HTTP(S)”) PUT message including the user trigger information for the SOCIAL-REF server 120 in the form of data formatted according to the eXtensible Markup Language (“XML”). Below is an example HTTP(S) PUT message including an XML-formatted user trigger for the SOCIAL-REF server:

```
PUT /trigger.php HTTP/1.1
Host: www.social-ref.com
Content-Type: Application/XML
Content-Length: 718
<?XML version = “1.0” encoding = “UTF-8”?>
<UserTrigger>
    <Sharing_UserID> JDoe <\Sharing_UserID>
    <Item>
        <ItemID> IZOD00001 </ItemID>
        <Item_Name> Sweater <\Item_Name>
        <Item_Model_Number> 123456 <\Item_Model_Number>
        <Item_Size> Medium <\Item_Size>
        <Item_Description>
            <Item_Manufacturer> Izod <\Item_Manufacturer>
            <Item_Materials> Wool/Cotton Blend<\Item_Materials>
            <Item_Color> Green <\Item_Color>
            <Item_Features> Loose fit, V-neck <\Item_Features>
            <Item_Instructions> Dry Clean Only <\Item_Instructions>
        <\Item_Description>
        <Item_OriginURL> www.onlinestore.com
        <\Item_OriginURL>
        <Item_Price> $45.00 <\Item_Price>
        <Item_Discount_Code>
            <Item_Coupon> 0% <\Item_Coupon>
            <Item_Sale> 20% <\Item Sale>
        <\Item_Discount_Code>
        ...
        <\Item>
    <Time> 19:29:56 </Time>
    <Date> 12-09-2000 </Date>
    <Source> Amazon.com </Source>
    <Activity> Add-to-Wish-List </Activity>
    ...
<\UserTrigger>
```

In alternative implementation, the merchant 135 may provide the share item information to the SOCIAL-REF server 120, as illustrated at 136 in FIG. 1D.

Within implementations, the SOCIAL-REF server 120 may forward the user trigger activity 107c to a share channel 144, e.g., a social media platform (e.g., Facebook, Twitter, etc.), an email server, a mobile message server, etc. In one implementation, the share channel 144 may generate referral news feeds 118 based on the received user trigger 107c, e.g., a Facebook post (see 118a in FIG. 1A), etc.

In one implementation, the referral news feeds 118 may be generated by a share channel 144. In one implementation, the share channel may receive user's subscription/follower configuration criteria and rules 113, and determine whether and to whom the referral news feeds 118 may be shared. For example, a user 102 may elect to subscribe to another SOCIAL-REF user so that the user 102 may receive the other user's referral news feeds (e.g., see FIG. 5C). For another example, the user 102 may configure access control parameters (e.g., see FIG. 5B) to allow a group of friends to view his published referral news feeds 118. In further implementations, the user 102 may submit such subscription configuration information 113 to the SOCIAL-REF server 120.

For example, the user may provide a HTTPS PUT message including the user configured parameters for the SOCIAL-REF server 120 in the form of data formatted according to the XML. Below is an example HTTP(S) PUT message including an XML-formatted user access control configuration message for the SOCIAL-REF server:

```
PUT /accesscontrol.php HTTP/1.1
Host: www.social-ref.com
Content-Type: Application/XML
Content-Length: 718
<?XML version = “1.0” encoding = “UTF-8”?>
<AccessControlRule>
    <Sharing_UserID> JDoe <\Sharing_UserID>
    <UserName> John Doe </UserName>
    <SubmissionTime> 19:29:45 </SubmissionTime>
    <Date> 12-09-2000 </Date>
    <ShareChannel> Facebook </ShareChannel>
    <ShareCategory>
        <Category1> Electronics </Category1>
        <Category2> Digital Camera </Cagetory2>
        ...
    </ShareCategory>
    <InerestsGroup>
        <WhiteList>
            <User1> Taylor Q </User1>
            <User2> John Smith </User2>
            ...
        </Whitelist>
        <Restricted>
            <Rule> Confirmation requested </Rule>
            <User1> Wu Wei </User1>
            <User2> Walt Paul </User2>
            ...
        </Restricted>
        ...
    </InterestsGroup>
    <ShareTrigger>
        <Trigger1> purchase </Trigger1>
        <Trigger2> Add to wish list </Trigger2>
        ...
    </ShareTrigger>
    <ShareSource>
        <Source1> Amazon.com </Source1>
        <Source2> GPS </Source2>
        ...
    </ShareSource>
    ...
<\AccessControlRule>
```

In the above example, the user “John Doe” may have configured his access control rule on SOCIAL-REF such that his activities related to items in the category “Electronics->Digital Camera” will be shared on “Facebook.” The user has further created an interests group to allow his Facebook friends “Taylor Q,” “John Smith,” etc. to view his SOCIAL-REF feeds on Facebook, while “Wu Wei,” “Walt Paul” may need to request permission if they desire to view “John Doe's” share item on Facebook. The user may also configure that his activities including a “purchase” of an item, “add to wishlist,” etc. will be published on Facebook. Such activities may transmitted from “Amazon.com,” SOCIAL-REF GPS service (e.g., the user operates his mobile wallet to purchase an item at a physical store, see FIGS. 6A-6F, etc.), and/or the like. Further examples of user access control to subscribers are discussed in FIG. 5B.

For another example, an exemplary XML record of the user subscription list 113 may take a form similar to:

```
PUT /usersubscription.php HTTP/1.1
Host: www.social-ref.com
Content-Type: Application/XML
Content-Length: 718
<?XML version = “1.0” encoding = “UTF-8”?>
<MySubscription>
          <UserID> JDoe <\UserID>
          <UserName> John Doe </UserName>
          <LastUpdateTime> 19:29:45 </LastUpdateTime>
          <Date> 12-09-2000 </Date>
          <ShareChannel> Facebook </ShareChannel>
          <Subscription1>
                <Name> John Smith </Name>
                <MyLabel> Electronics Expert </MyLabel>
                <Category>
                <Category1> Electronics </Category1>
                <Category2> Digital Camera </Cagetory2>
                ...
                </Category>
          ...
          <Subscription1>
          <Subscription2>
                <Name> Taylor Q </Name>
                <MyLabel> My Fashion Icon </MyLabel>
                <Category>
                <Category1> Apparel and Accessories </Category1>
                <Category2> Handbags </Cagetory2>
                ...
                </Category>
          ...
          </Subscription2>
          ...
</MySubscription>
```

In the above example, the user “John Doe” may have subscribed to a few of his Facebook friends and label them accordingly to receive SOCIAL-REF referral news feeds from them. For example, “John Doe” has subscribed to “John Smith” and label “John Smith” as an “Electronics Expert” so that “John Doe” will see “John Smith's” referral messages in the category “Electronics->digital camera.” For another example, “John Doe” has subscribed to “Taylor Q” and label “Taylor Q” as a “Fashion Icon” so that “John Doe” will see “Taylor Q's” referral messages in the category “Apparel and Accessories->Handbags.” Further examples of user access control to subscribers are discussed in FIG. 5C.

Within embodiments, the share channel 144 may track the user's 102 followers activities 115, and send the tracking information to the SOCIAL-REF server 120. For example, the share channel 144 and/or he SOCIAL-REF server 120 may track the usage of the followers with regard to the share item, e.g., the followers' comments on the share item, purchase, adds to wishlist, and/or the like. The SOCIAL-REF server 120 may calculate referral fees for the user based on the tracking follower activities 115, and send referral fee information 116a to the merchant/sponsor 135. The sponsor 135 may in turn make referral fee payment 116b to the user 102 (e.g., see FIGS. 2A-4). For example, the sponsor may provide a HTTPS PUT message including referral fee payment information for the user in the form of data formatted according to the XML. Below is an example HTTP(S) PUT message including an XML-formatted referral fee payment message:

```
PUT /referralfee.php HTTP/1.1
Host: www.social-ref.com
Content-Type: Application/XML
Content-Length: 718
<?XML version = “1.0” encoding = “UTF-8”?>
<ReferralPayment>
      <PaymentID> 0000 0000 <\PaymentID>
      <PayeeID> JDoe </PayeeID>
      <Time> 19:29:56 </Time>
      <Date> 12-09-2000 </Date>
      <Item>
            <ItemID> IZOD00001 </ItemID>
            <Item_Name> Sweater <\Item_Name>
            <Item_Model_Number>
            123456 <\Item_Model_Number>
            <Item_Size> Medium <\Item_Size>
            <Item_Description>
                  <Item_Manufacturer> Izod <\Item_Manufacturer>
                  <Item_Materials> Wool/Cotton
                  Blend<\Item_Materials>
                  <Item_Color> Green <\Item_Color>
                  <Item_Features> Loose fit,
                  V-neck <\Item_Features>
                  <Item_Instructions> Dry Clean
                  Only <\Item_Instructions>
            <\Item_Description>
            <Item_OriginURL>
            www.onlinestore.com <\Item_OriginURL>
            <Item_Price> $45.00 <\Item_Price>
            <Item_Discount_Code>
                  <Item_Coupon> 0% <\Item_Coupon>
                  <Item_Sale> 20% <\Item Sale>
            <\Item_Discount_Code>
            ...
            <\Item>
      <Source> Amazon.com </Source>
      <Activity> Add-to-Wish-List </Activity>
      <ReferralChain>
            <1stD> John Smith </1stD>
            <1stDFee> $20.00 </1stDFee>
            <2ndD> John Smith </1ndD>
            <2ndDFee> $10.00 </ndtDFee>
      ...
      </ReferralChain>
...
<\ReferralPayment>
```

In one embodiment, the SOCIAL-REF server 120 may establish data records of users, merchants, sponsors, past user triggers, user follower activities, referral payment transactions 123 for storage in a database 119. For example, the database 119 may be a relational database responsive to Structured Query Language (“SQL”) commands. The SOCIAL-REF server may execute a hypertext preprocessor (“PHP”) script including SQL commands to query the database for user, share item, transaction data. An example PHP/SQL command listing, illustrating substantive aspects of storing referral fee payment data (e.g., referral fee payment 116b, etc.) in a database (e.g., a transaction record 123, etc.):

<?PHP
header(‘Content-Type: text/plain’);
mysql_connect(″254.92.185.103”,$DBserver,$password); // access
database server
mysql_select(″TRANSACTIONS.SQL″); // select database to append
mysql_query(“INSERT INTO Transactions (PaymentID, PayeeID,
timestamp, Date, ItemID, Item_Name, Item_Model, Item_Size,
Item_Description, Item_OriginURL, Item_Price,
Item_DiscountCode, ... , Souce, Activity, ReferralChain, ...)
VALUES ($PaymentID$, $PayeeID$, time( ), $Date$, $ItemID$,
$Item_Name$, $Item_Model$, $Item_Size$, $Item_Description$,
$Item_OriginURL$, $Item_Price$, $Item_DiscountCode$, ..., $Souce$,
$Activity$, $ReferralChain$, ...
); //
add data to table in database
mysql_close(″TRANSACTIONS.SQL″); // close connection to database
?>

For another example, a merchant registry at the SOCIAL-REF may comprise data entries such as, but not limited to merchant ID, merchant URL, URI, US DMA, MSA, NAICS codes, position coordinates, latitude, longitude, consumer preferences, opt-in activities, history, offer notifications, messaging campaign settings, campaign management, offer delivery, messaging, redemption, analytics, and/or the like. In a further implementation, the SOCIAL-REF may support wholesale API delivery of embodiments of the SOCIAL-REF. Further implementations of the database 119 are discussed in FIG. 1D.

FIG. 1D is a block diagram illustrating data flow from one or more client/user(s) to one or more server(s) in an embodiment of the SOCIAL-REF. In this embodiment, a user 102 may input login information 105 into the client computer 104. In one implementation, received user input may take a form similar to the following XML record:

```
PUT /Login.php HTTP/1.1
Host: www.social-ref.com
Content-Type: Application/XML
Content-Length: 718
<?XML version = “1.0” encoding = “UTF-8”?>
<Login_Information_Submitted>
                <Username> JDoe <\Username>
                <Password> J@neJ0hn <\Password>
<\Login_Information_Submitted>
```

This information is sent 110 to the server 106, and, upon verification, the server permits the user 102 to access his or her account. In some implementations, the server provides a tracking component 115, which may be executed, activated, instantiated, and/or implemented by the client (and/or associated components and/or programs) 120. The user may surf or browse the Internet 125 (e.g., retail Web sites, blogs, consumer report Web sites, advertisements, etc.) and may upload content to the server 136 (e.g., via the loading component) by selecting a share item 130 which he or she would like to save, purchase, and/or share with others. In one implementation, received user input may take a form similar to the following XML record:

```
PUT /shareitem.php HTTP/1.1
Host: www.social-ref.com
Content-Type: Application/XML
Content-Length: 718
<?XML version = “1.0” encoding = “UTF-8”?>
<Share_Item_Selected>
            <Sharing_User> JDoe <\Sharing_User>
            <Item_Name> Green Sweater <\Item_Name>
            <Item_Model_Number>
            123456 <\Item_Model_Number>
            <Item_Size> Medium <\Item_Size>
            <Item_Description>
                  <Item_Manufacturer> Izod <\Item_Manufacturer>
                  <Item_Materials> Wool/Cotton
                  Blend<\Item_Materials>
                  <Item_Color> Green <\Item_Color>
                  <Item_Features> Loose fit,
                  V-neck <\Item_Features>
                  <Item_Instructions> Dry Clean
                  Only <\Item_Instructions>
            <\Item_Description>
            <Item_OriginURL>
            www.onlinestore.com <\Item_OriginURL>
            <Item_Price> $45.00 <\Item_Price>
            <Item_Discount_Code>
                  <Item_Coupon> 0% <\Item_Coupon>
                  <Item_Sale> 20% <\Item Sale>
            <\Item_Discount_Code>
<\Share_Item_Selected>
```

If the user elects to share the item, an interface and/or other tool or component may be presented to the user or configured to allow the user, via the SOCIAL-REF, to share or send the information to others 140, e.g., via email, messaging via the SOCIAL-REF (i.e., to another user) and/or via one or more social networking Web sites. In another embodiment, the SOCIAL-REF may present the user with an interface or the like showing or displaying email addresses or social networking sites (and/or the like) that the user (and/or other users) commonly selects as targets for item sharing. In another embodiment, a user's common share targets may be stored in a database on a SOCIAL-REF server (and/or associated server(s)), such that the user may select a share target's name and the server may search the database to find the target's preferred contact information (e.g., the target's email address, if the target prefers being contacted by email or inter-system message, etc.). In one implementation, the information sent from the server to the client may take a form similar to the following XML record:

```
PUT /sharechannel.php HTTP/1.1
Host: www.social-ref.com
Content-Type: Application/XML
Content-Length: 718
<?XML version = “1.0” encoding = “UTF-8”?>
<Channel_Option_Suggestions>
                  <Email>
                  <Frequent_Email_Share_Targets> Joe; Jerry
</Frequent_Email_Share_Targets>
                  <New_Email_Address_Field>
                  <\New_Email_Address_Field>
                  <\Email>
                  <Facebook>
                        <Frequently_Messaged_Friends> Jess; Julie
<\Frequently_Messaged_Friends>
                        < Facebook_Friends_List>
Aaron...Zelda <\Facebook_Friends_List>
                        <Post_on_Facebook_Wall> Yes
                        <\ Post_on_Facebook_Wall>
                  <\ Facebook>
<\Channel_Option_Suggestions>
```

The user may then select one or more of the presented options 145, and this information is sent to the server. In one implementation, this may take the form of the following XML record:

```
PUT /sharechannel.php HTTP/1.1
Host: www.social-ref.com
Content-Type: Application/XML
Content-Length: 718
<?XML version = “1.0” encoding = “UTF-8”?>
<Channel_Options_Selected>
          <Email>
                  <Frequent_Email_Share_Targets> Jerry
</Frequent_Email_Share_Targets>
                  <New_Email_Address_Field> Jezibel@email.com
<\New_Email_Address_Field>
          <\Email>
          <Facebook>
                  <Frequently_Messaged_Friends> Jess
<\Frequently_Messaged_Friends>
                  < Facebook_Friends_List> Aaron,
Adam <\Facebook_Friends_List>
                  <Post_on_Facebook_Wall> Yes
                  <\ Post_on_Facebook_Wall>
          <\ Facebook>
<\Channel_Options_Selected>
```

In some embodiments, the server may search for the shared user information 150 to determine, for example, the shared user's contact information. In one implementation, the server may tally the number of email addresses, account holders, and social network uploads a user selects. This tally may occur by establishing a counter, and the counter is increased by one for each share, purchase, and/or save, etc. In an embodiment, the shares, purchases, saves, etc., may be counted and stored individually, such that there may be different tallies for each (i.e., a share tally, purchase tally, etc.). The tally may be stored in the database 155. The user may then receive an output message indicating that the message has been distributed or shared 160. In one implementation, the user may receive a notification when a share target has viewed the share item, and may also receive a message when a share target has provided a recommendation or purchased a share item. In another implementation, this may take the form of the following XML record:

```
PUT /Notification.php HTTP/1.1
Host: www.social-ref.com
Content-Type: Application/XML
Content-Length: 718
<?XML version = “1.0” encoding = “UTF-8”?>
<Notification_Message_Sent>
                  <List_Email_Recipients> Jerry@email.com;
Jezibel@email.com <\List_Email_Recipients>
                  <Email_Sent_Confirm> Jerry@email.com:Y
Jezibel@email.com:Y <\Email_Sent_Confirm>
                  <Facebook_Message_Confirm > Jess:Y Aaron:Y
Adam:Y <\Facebook_Message_Confirm>
                  <Facebook_Wall_Post> Success!
                  <Facebook_Wall_Post>
<\Notification_Message_Sent>
```

In another embodiment, the user may decide to purchase the selected item 165 and may continue to purchase 170. In one implementation, this may take the form of the following XML record:

```
PUT /itemselection.php HTTP/1.1
Host: www.social-ref.com
Content-Type: Application/XML
Content-Length: 718
<?XML version = “1.0” encoding = “UTF-8”?>
<Purchase_Item_Selection>
                  <Item_Info> (Retrieved from
                  Share_Item_Selected) <\Item_Info>
                  <Gift_Wrap> No <\Gift_Wrap>
                  <Purchase_Method> Visa Credit
                  Card <\Purchase_Method>
                  <Credit_Card_Number> 4123 4567 8901
                  2345 <\Credit_Card_Number>
                  <Shipping_Option> US Post Office Standard 3-5
Day <\Shipping_Option>
                  <Tracking_Information> E123456789
                  <\Tracking_Information>
<\Purchase_Item_Selection>
```

The server may process this transaction 175 and may update the store counts 180 in the database. In a further implementation, purchases may be tallied separately from share counts. In some implementations, at certain time intervals or periods, the server may tally the number of times each item has been shared. In some embodiments, the server may also tally the number of times the item has been purchased. These tallies may be generated for each sponsor 185. In one implementation, this may take the form of the following XML record:

```
PUT /sponsor.php HTTP/1.1
Host: www.social-ref.com
Content-Type: Application/XML
Content-Length: 718
<?XML version = “1.0” encoding = “UTF-8”?>
<Sponsor_Share_Count>
                  <Number_Shares> 100 <\Number_Shares>
                  <Number_2ndDegree_Shares> 50
                  <\Number_2ndDegree_Shares>
                  <Number_3rdDegree_Shares> 25
                  <\Number_3rdDegree_Shares>
                  <Number_Purchases> 50 <\Number_Purchases>
                  <Number_2ndDegree_Purchases> 20
                  <\Number_2ndDegree_Purchases>
                  <Number_3rdDegree_Purchases> 5
                  <\Number_3rdDegree_Purchases>
                  <Number_Recommendations> 20
                  <\Number_Recommendations>
<\Sponsor_Share_Count>
```

In one embodiment, these tallies may be used to determine the fees due from each sponsor 190. In one embodiment, this output may take the form of the following XML record:

```
PUT /sponsorbill.php HTTP/1.1
Host: www.social-ref.com
Content-Type: Application/XML
Content-Length: 718
<?XML version = “1.0” encoding = “UTF-8”?>
<Sponsor_Bills>
                  <Fee_per_Share> $1.00 <\Fee_per_Share>
                  <Fee_per_2ndDegree_Share> $1.25
                  <\Fee_per_2ndDegree_Share>
                  <Fee_per_3rdDegree_Share> $1.50
                  <\Fee_per_3rdDegree_Share>
                  <Fee_per_Purchase> $2.00 <\Fee_per_Purchase>
                  <Fee_per_2ndDegree_Purchase> $2.25
                  <\Fee_per_2ndDegree_Share>
                  <Fee_per_3rdDegree_Purchase> $2.50
<\Fee_per_3rdDegree_Purchase>
                  <Fee_per_Recommendation> $0.50
                  <\Fee_per_Recommendation>
                  <Sponsor_Share_Count> from
                  above <\Sponsor_Share_Count>
                  <Total_Fee_Due> $380.00 <\Total_Fee_Due>
<\Sponsor_Bills>
```

FIGS. 2A-2B provide logic flow diagrams illustrating SOCIAL-REF user-server interactions within implementations of the SOCIAL-REF. Within embodiments, the user 102 may submit a submission request to the SOCIAL-REF 120. For example, the user may submit his profile information (e.g., user account name, user password, user name, user contact, etc.) to create a SOCIAL-REF account. For another example, the user may indicate a share channel, such as the user's email account, the user's Facebook account, the user's Twitter account and/or the like so that the SOCIAL-REF account may link to the share channel. For a further example, the user may provide his financial account information to create an electronic wallet (e.g., Visa V-Wallet, etc.) service via the SOCIAL-REF, e.g., the user's credit card account, checking account, PayPal account, etc.

In one implementation, the SOCIAL-REF may receive user submitted registration request and information to create a user SOCIAL-REF account, and link to the user indicated share channel 223. For example, upon receiving user's share channel account, the SOCIAL-REF may send an authentication message via the share channel (e.g., a confirmation email message, a Facebook message, a Twitter private message, etc.) and request the user to click on an authentication link included in the message. If the user successfully clicks on the authentication link, the share channel 144 may confirm connection has been established with the SOCIAL-REF 225.

In one implementation, the user may log into his SOCIAL-REF account via a SOCIAL-REF userinterface. In one implementation, SOCIAL-REF may provide a web-based (and/or mobile) user interface for the user to view, modify and save configuration setting parameters. In another implementation, SOCIAL-REF may provide a component to the user's share channel so that the user may directly configure his SOCIAL-REF settings on the share channel. For example, a Facebook user may be prompted to install a SOCIAL-REF application on his Facebook account upon registration with SOCIAL-REF, and may configure his SOCIAL-REF settings via his Facebook profile.

For example, FIG. 5A provides an example schematic user interface of SOCIAL-PAY user profile page within implementations of the SOCIAL-PAY. As shown in FIG. 5A, the SOCIAL-REF UI may comprise a panel for the user to select items to publish 505. For example, the user may check categories of share items to publish, e.g., “Electronics” 508. Once the user has selected a category, the user may be prompted to select subcategories under “Electronics,” e.g., “Laptop&Computers, Accessories” 508a, “Television” 508b, “Digital Camera” 508c, “Printer, Scanner” 508d, and/or the like, and/or to specify a subcategory not listed 508f. In another implementation, the user may elect to control access to his publications under the selected category, e.g., privacy control 520 settings. For example, the user may elects to manually select users from his contact list to allow them to access his publication under the category “Electronics.”

In one implementation, the SOCIAL-REF UI may show a list of the user's followers 530, and the created interests group 530a-530c. For example, the user may create interests groups so that each interest group may see the user's publications, news feeds with regard to share items of a category, e.g., interests group 1 530a may see share item publications under the category “Electronics”; interests group 2 530b may see share item publications under the category “Beauty”, and/or the like. Further implementations of creating a new interests group and privacy control are discussed in FIG. 5B.

In one implementation, the SOCIAL-REF UI may provide an overview of the user's referral fee revenue. For example, the user may view a total referral revenue chart per month 535a. For another example, the user may view a pie of total revenue by category 535b. For a further example, the user may view a referral revenue break-down per degree of separation. For a further example, the user may view a list of referral fee payment history per transaction timestamp, and/or the like.

In further implementations, the SOCIAL-REF UI may comprise a list of followers' feedbacks 540. Further examples of the followers' feedbacks are discussed in FIG. 6D.

Back to FIG. 2A, at 227, the user may submit configure SOCIAL-REF privacy setting 227 (e.g., see 520 at FIG. 5A and FIG. 5B). For example, as shown in FIG. 195B, the user may create interests group of his followers to control their access to his SOCIAL-REF publication.

As shown in FIG. 5B, in one implementation, the user may select an interests category from the interests category list 541. For example, the user may select a category “Electronics” 541a. Upon selecting the category, SOCIAL-REF may expand the category “Electronics” 541a with a list of subcategories, and the user may select a subcategory “Digital Camera” 541b. Upon checking the checkbox, the user has selected to share his activities related to “Digital Camera” over a share channel.

In one implementation, the user may select whether he would like his SOCIAL-REF publication to include any advertisement, or any related products 542. For example, if the user elects to include related products in the SOCIAL-REF publication, the user may further configure parameters about the related products, e.g., the related products must be in “Digital Camera” 542a, the related products must have the same make and model with the share item 542b, etc. In further implementations, the related products may comprise share items shared by other SOCIAL-REF users, wherein the user may select a degree of separation between those users and himself, e.g., degrees. For example, when a user's recent purchase of a “Canon SX20IS” camera has been published on Facebook (e.g., see 118a in FIG. 1A), SOCIAL-REF may include additional recommendations such as “You may also be interested in: Canon SX30IS” and/or the like.

In one implementation, for the selected category “Electronics->Digital Camera,” the user may configure social privacy settings 545. For example, the user may select a degree of separation of SOCIAL-REF users that can follow and see his SOCIAL-REF publications, e.g., 550a. For example, the user may select Facebook users within 3 degrees can view his SOCIAL-REF publications under the category “Digital Camera.” For another example, the user may import friends from other social media platform (e.g., MySpace, Google+, etc.), email list (e.g., Gmail, etc.) and/or the like. For another example, the user may specify a group of contacts may access his SOCIAL-REF publications 550b. For example, the user may specify Facebook friends categorized as “Work Friends” can access his SOCIAL-REF publication.

In one implementation, the user may further configure the content of SOCIAL-REF publications 550c. For example, the user may elect to only publish news feeds that he has given the highest rating (e.g., five star, etc.), items that he has added to wishlist or has purchased, and/or the like. In further implementations, the user may allow SOCIAL-REF to retrieve and publish GPS information when he purchases a share item at a physical store (see 575b in FIG. 5C).

Back to FIG. 2A, at 230, the user may submit user subscription information to other SOCIAL-REF users. For example, the user may be interested in receiving SOCIAL-REF news feeds from one or more of his Facebook friends, seeing what his friends have bought, or have added to wishlist. In one implementation, as shown in FIG. 5C, the user may configure subscription settings via a user interface. For example, the user may select a category of items he is interested in, e.g., “Electronics->Digital Camera.” In one implementation, SOCIAL-REF may recommend friends for the user to follow 56o related to “Digital Camera.” For example, SOCIAL-REF may query the user's friends list on a label that is assigned to an individual by his follower 560a, wherein the individual's label may indicate this individual is followed by others as versed in “Digital Camera,” etc. For example, SOCIAL-REF may recommend “John Doe” to the user to follow, because “John Doe” has been labeled by “John Doe's” followers as related to “Electronics,” “Camera Geek,” e.g., 560a.

In one implementation, upon selecting to follow “John Doe,” the user may opt to specify his own label for this subscription 560b. For example, the user may label “John Doe” as for “Electronics” 575a so that the user may know this subscription for “John Doe” is for news feeds related to “Electronics.” In another example, e.g., at 575b, the user may label his subscription to “Taylor Q” as “My Fashion Icon” so that the user may know the subscription to “Taylor Q” is for news feeds related to fashion goods.

In one implementation, the user may view a list of subscription updates 575. In one implementation, SOCIAL-PAY may provide GPS information of a physical store when a SOCIAL-PAY user operate a GPS enabled mobile device (e.g., an Apple iPhone, etc.) to make a purchase via a mobile wallet. For example, when “Taylor Q” purchases a handbag at “Saks 5^{th} Ave” in New York with her mobile wallet, the SOCIAL-REF may automatically receive GPS information of the physical store and publish it with the news feeds, e.g., 575b. Further implementations of SOCIAL-REF mobile wallet are discussed in FIGS. 6A-6F.

Back to FIG. 2A, upon user submission of configurations, SOCIAL-REF may validate user configuration data and set up registration parameters 235 with the share channel 144, e.g., Facebook, Twitter, Google+, etc.

In one implementation, a user may trigger the SOCIAL-REF by submitting a share item 238a. For example, the user may purchase an item, add an item to his wishlist, give a high rating of an item, “like” an item on Facebook, and/or the like. For another example, the SOCIAL-REF may receive the indication of share item 239 from a merchant and/or sponsor 238b. For example, a user may purchase an item at a merchant site, at a physical merchant store, and/or the like, e.g., 238b.

Upon receiving the indication of share item 239, the SOCIAL-REF may determine whether the share item is sharable per the user's privacy setting at 227, e.g., at 240. For example, if the user only elects to share items in “Digital Camera,” but the indicated share item is a cosmetic product, such share item is not sharable per user's privacy setting, and SOCIAL-REF 120 may monitor user activity 248.

If the share item satisfies the user sharing privacy setting 245, the SOCIAL-REF 120 may send a share request 250 to a share channel, which may in turn publish the share item in the user's news feeds (e.g., 118a in FIG. 1A), e.g., 255.

Continuing on with FIG. 2B, upon sharing, the SOCIAL-REF may determine whether the share item is associated with a unique SOCIAL-REF identifier for tracking, e.g., 257. The SOCIAL-REF may retrieve the SOCIAL-REF ID of the share item if such ID already exists for the share item, or may create a new ID for tracking the share item if such ID has not been associated with the share item yet.

In one implementation, the SOCIAL-REF may receive an indication of the user's follower purchase 258 of the share item, and may determine whether the purchase of the item, e.g., at 238a/b, is referred by the user 102 follows. The SOCIAL-REF may query on the follower's subscriptions based on the item's SOCIAL-REF ID 260. If such subscription news feeds is found, e.g., the user may be referred by another SOCIAL-REF individual 262, the share channel 144 may determine a degree of separation 265, and calculate a referral fee based on the degree of separation 270. For example, in the example shown in FIG. 1B, if the second degree follower 103.2 has bought a share item, SOCIAL-REF's query (e.g., 260) shows the second degree follower has followed the first degree follower who has published news feeds related to the share item. In such cases, the first degree follower is to be awarded a referral fee. In one implementation, the SOCIAL-REF may continue querying on the first degree follower's 103.1 subscriptions based on the item ID, and may find the first degree follower has followed the user 102 who has published news feeds related to the share item. In one implementation, the SOCIAL-REF may continue querying upwards along the referral chain until the first person who has published news feeds of the share item has been located. In another implementation, the SOCIAL-REF may query the referral chain within the maximum allowed degree of separation, which may be specified by the sponsor. For example, the sponsor may specify referrals within two degrees of separations are to be rewarded.

In one implementation, the SOCIAL-REF 120 may facilitate the sponsor to make payment of the calculated referral fee to the user 275. Within implementation, the rewards may be monetary rebate to the user's SOCIAL-REF electronic wallet. In other implementations, the rewards may be in the form of coupon codes, offers, virtual currency points (e.g., Amazon points, etc.), and/or the like. The SOCIAL-REF may periodically monitor purchasing information of the share item via the SOCIAL-REF platform 28o to help the user collect referral fees.

FIG. 2C shows alternative embodiments of the SOCIAL-REF interaction between client 201 and the server 202 as the first user seeks to find items to share and/or purchase. The user logs into the system 203 and is authenticated by the server 204. The server may also provide a tracking component 205 which may be received and instantiated by the client 206. Depending on the embodiment, the client may load a tracking component installed or instantiate in a user's browser and/or onto the user's computer. The user surfs the Internet 207 via the client and finds an item 208. For the sake of non-limiting example, the user is looking for a sweater. The user may surf the internet, including several different online clothing and department stores. This item may be selected 209 (e.g., added to a wish list), purchased 210, and/or shared 212. In the case of the example, the user finds several sweaters in which (s) he is interested. The user selects each of these and adds them to his/her wish list. The user may then access the wish list that has been created, and view all of the sweaters that have been added to the list.

In one embodiment, the user may request to purchase and/or share the item; in another the server prompts the user to answer whether or not they would like to purchase and/or share the item. Continuing the example from above, the user views the item(s) and may choose to either purchase and/or share the item with friends. If the user decides to purchase the item, this activity may be tracked 211 and the user may then decide whether to share the item 212. In this case, the user buys the item and the server inserts a tracker into the URL hyperlink that may record each time the product is shared and/or purchased. The server may record that the item has been purchased, and the user may choose to share with friends the item that the user has purchased. If the user chooses not purchase the item, the user may still choose to share the item. The user may seek advice as to which sweater to buy or may have found a sweater in which the user thinks a friend would be interested. Should the user determine not to share the item, the user may return to surfing the Internet 207. In this case, the user may return to browsing the Internet for more sweater options or other items. If the user shares the item, the tracking component/client may provide indication to the server that the user wishes to share the item 213 and identifies share targets 214 with whom the user would like to share the item. In some embodiments, the user may specify the channels over which to share the item 215. By way of non-limiting example, these channels include email, social networking Web sites, etc. The user then triggers distribution to the share targets 216 and the server distributes the information and tracks the shared item 217. If the user decides to share the sweater(s) in the wish list, the server may attach a tracking link or code to the hyperlink to record the number of times and various methods the item is shared, such as via email or social networking Web site. The user identifies friends with whom to share the selected sweater(s) and whether to contact them via email or social networking site. The user also ahs the option to post the item in a social networking site where many people could access a link.

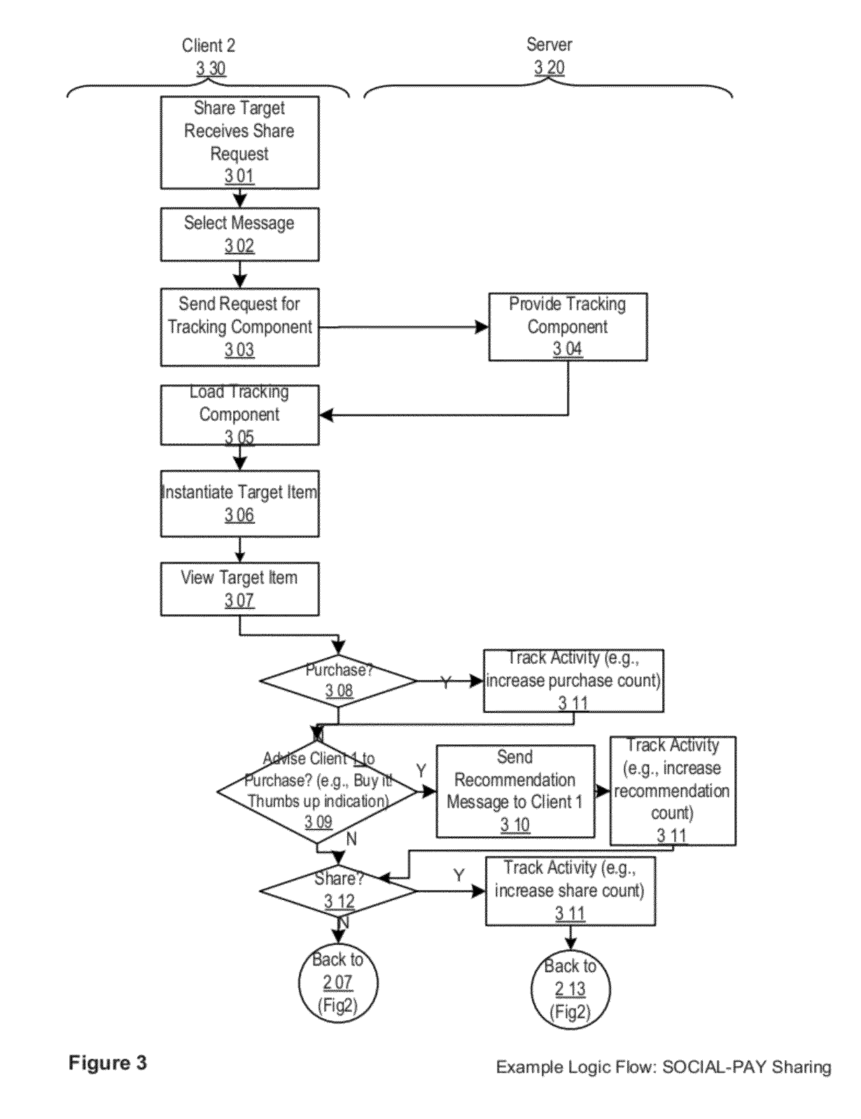

FIG. 3 illustrates the interaction between the server 320 and client 2 330, the recipient of a shared item. The second user, the target share, receives share request 301, indicating that the first user has shared an item with the second user. In the example used above, the first user shares a sweater with a second user. The second user may select the message 302 and the client may send a request for the web tracker 303. The server provides the web tracker 304 and client 2 loads the web tracker 305. Client 2 can then instantiate 306 and the second user may view the item 307.

The second user receives a notification, for example in an email account, indicating that the first user has shared an item. The second user may select the email and view the item the first user has shared. The second user may decide whether to purchase the product 308. In one embodiment, the second user may request to purchase the item; in another the server may present the second user with an option to purchase. In either case, if the second user decides to purchase, the server tracks this activity 311. The server may input a new or appended tracking link or code that tracks a second degree purchase (i.e., friend of the first user) on a shared item. In the example, the second user views the sweater that the first user found while surfing the Internet and decides to purchase the sweater. The server tracks this activity and increases the purchase count. If the second user opts not to purchase, the second user may choose whether to advise the first user on whether the first user should purchase the item 309. If the second user provides advice, a recommendation message may be sent to the first user. By way of example, the second user may opt not to purchase the sweater, but suggests to the first user that the sweater would be an excellent choice. This activity may be tracked 311 by the server in a similar manner as above, and the server may tally this as a recommendation count

The second user may have the option to share the item 312. If the second user opts not to provide advice to the first user, the second user may decide whether to share the item 312. If so, this is tracked 311 and the second user begins at 213 in FIG. 132; if not, the second user may surf the web, 207 (FIG. 2). The second user may decide to share the sweater with another friend, in which case the server may add/append a tracking hyperlink that would indicate a third degree share (friend of friend of the first user). The second user then may follow similar steps as the first user in FIG. 2, 213. Alternatively, the second user may choose not to share the item, in which case the user returns to surfing the web, FIG. 2, 207.

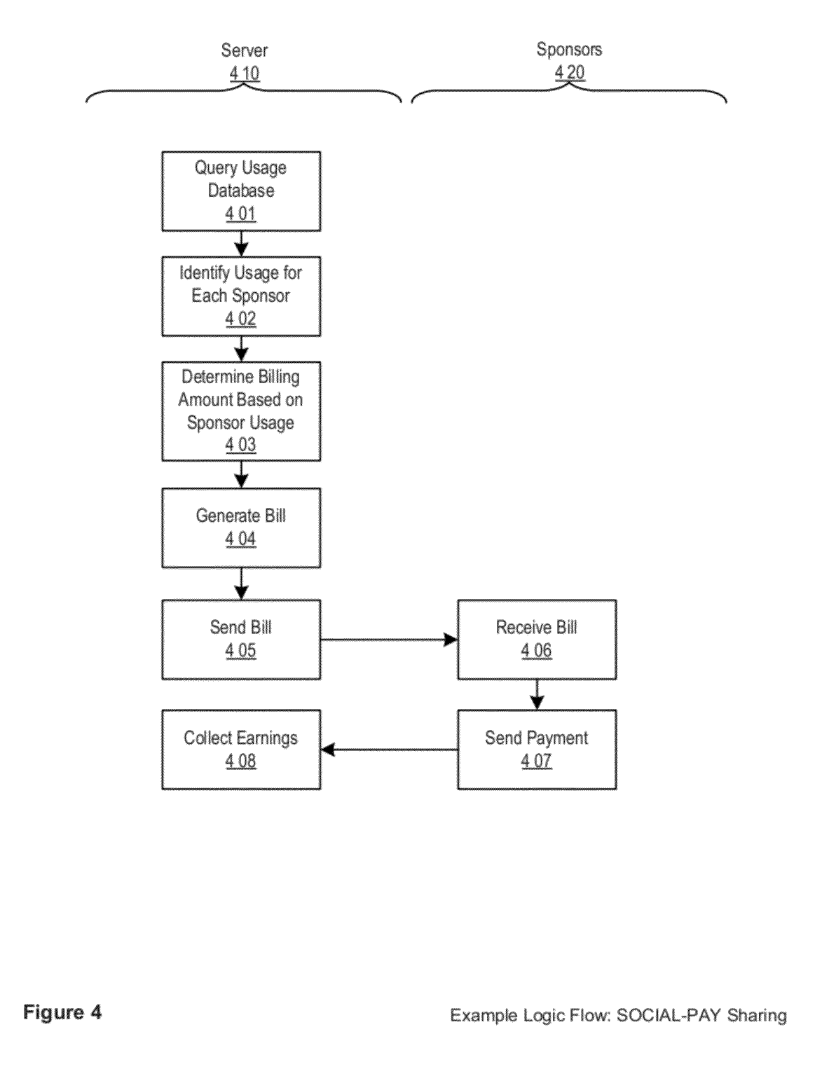

FIG. 4 illustrates the server interaction with the sponsors. In one embodiment, the server may query the usage database 401 and may identify the usage for each sponsor 402. Based on sponsor usage, the server may determine the number of shares, recommendations, purchases, etc. and determine an amount to charge each sponsor 403. In some embodiments, different interactions or actions may have different charges or fees associated with them. in one implementation, a user adding an item to his or her wish list may be associated with a certain fee (e.g., $0.02), and if the user shares the item, additional or alternative fees may be determined. For example, if a user shares the item with a friend via email, a fee of $0.03 may be determined, while if the user posts the share item to a social network, a fee of $0.06 may be determined. In a further implementation, fees may be determined based on user information (e.g., the fee for sharing an item via a social network may be determined to be higher for a user that has 350 friends than for a user that has 70 friends). The server may then generate the bill for the sponsor 404 and send the bill to the sponsor 405. The sponsor receives the bill 406 and may submits payment 407. The server may then collect and process the payment 408. Depending on the implementation, the SOCIAL-REF may provide sponsor account tracking, including payment tracking.

Depending on the embodiment, the SOCIAL-REF may be implemented and/or administered by a variety of entities. For example, in one implementation, the SOCIAL-REF may be implemented by a service or entity that facilitates online payments. In such an implementation, components and/or elements of the SOCIAL-REF may be implemented by users, sponsors, retailers, etc., to provide the features of the SOCIAL-REF.

FIGS. 6A-F show application user interface diagrams illustrating example features of a snap mobile payment app for capturing product barcodes, securing user data and preventing fraud in some embodiments of the SOCIAL-REF. With reference to FIG. 6A, in some implementations, the app executing on the device of the user may include an app interface providing various features for the user. In some implementations, the app may be configured to recognize product identifiers (e.g., barcodes, QR codes, etc.), e.g., 601. For example, the app may be configured to capture a SOCIAL-REF item identifier, so that a user may query for subscription news feeds related to the item based on the identifier. In some implementations, the user may be required to sign in to the app to enable its features. Once enabled, the camera may provide in-person one tap purchasing features for the user. For example, the client device may have a camera via which the app may acquire images, video data, streaming live video, and/or the like, e.g., 603. In some implementations, the app may overlay cross-hairs, target box, and/or like alignment reference markers, e.g., 605, so that a user may align the product identifier using the reference markers so facilitate product identifier recognition and interpretation. In some implementations, the app may include interface elements to allow the user to switch back and forth between the product identification mode and product offer interface display screens (see, e.g., 606), so that a user may accurately study deals available to the user before capturing a product identifier. In some implementations, the app may provide the user with the ability to view prior product identifier captures (see, e.g., 607) so that the user may be able to better decide which product identifier the user desires to capture. In some implementations, the user may desire to cancel product purchasing; the app may provide the user with a user interface element (e.g., 608) to cancel the product identifier recognition procedure and return to the prior interface screen the user was utilizing. In some implementations, the user may be provided with information about products, user settings, merchants, offers, etc. in list form (see, e.g., 609) so that the user may better understand the user's purchasing options. Various other features may be provided for in the app (see, e.g., 610).

In FIG. 6B, upon inputting a product information, e.g., the scanning of the product barcode in FIG. 6A, the user may tap on “Social Subscription” 612a to view a list of news feeds related to the products from the user's subscriptions. In another implementation, upon purchasing, adding the product to wishlist, and/or the like, the user may tap on 612b “Social Stream” to see his followers' feedbacks, as illustrated in FIG. 6D.

With reference to FIG. 6C, in some implementations, the app may include an indication of the location (e.g., name of the merchant store, geographical location, information about the aisle within the merchant store, etc.) of the user, e.g., 611. The app may provide an indication of a pay amount due for the purchase of the product, e.g., 612. In some implementations, the app may provide various options for the user to pay the amount for purchasing the product(s). For example, the app may utilize the GPS coordinates to determine the merchant store within the user is present, and direct the user to a website of the merchant. In some implementations, the SOCIAL-REF may provide an API for participating merchants directly to facilitate transaction processing. In some implementations, a merchant-branded SOCIAL-REF application may be developed with the SOCIAL-REF functionality, which may directly connect the user into the merchant's transaction processing system. For example, the user may choose from a number of cards (e.g., credit cards, debit cards, prepaid cards, etc.) from various card providers, e.g., 613. In some implementations, the app may provide the user the option to pay the purchase amount using funds included in a bank account of the user, e.g., a checking, savings, money market, current account, etc., e.g., 614. In some implementations, the user may have set default options for which card, bank account, etc. to use for the purchase transactions via the app. In some implementations, such setting of default options may allow the user to initiate the purchase transaction via a single click, tap, swipe, and/or other remedial user input action, e.g., 615a. In some implementations, when the user utilizes such an option, the app may utilize the default settings of the user to initiate the purchase transaction. In some implementations, the app may allow the user to utilize other accounts (e.g., Google™ Checkout, Paypal™ account, etc.) to pay for the purchase transaction, e.g., 616. In some implementations, the app may allow the user to utilize rewards points, airline miles, hotel points, electronic coupons, printed coupons (e.g., by capturing the printed coupons similar to the product identifier) etc., to pay for the purchase transaction, e.g., 617-618. In other implementations, the user may receive referral fee payment as rewards, e.g., 618. In some implementations, the app may provide an option to provide express authorization before initiating the purchase transaction, e.g., 619. In some implementations, the app may provide a progress indicator provide indication on the progress of the transaction after the user has selected an option to initiate the purchase transaction, e.g., 620. In some implementations, the app may provide the user with historical information on the user's prior purchases via the app, e.g., 621. In some implementations, the app may provide the user with an option to share information about the purchase (e.g., via email, SMS, wall posting on Facebook®, tweet on Twitter', etc.) with other users and/or control information shared with the merchant, acquirer, payment network etc., to process the purchase transaction, e.g., 622. In some implementations the app may provide the user an option to display the product identification information captured by the client device (e.g., in order to show a customer service representative at the exit of a store the product information), e.g., 624. In some implementations, the user, app, device and or SOCIAL-REF may encounter an error in the processing. In such scenarios, the user may be able to chat with a customer service representative (e.g., VerifyChat 623) to resolve the difficulties in the purchase transaction procedure.

In some implementations, the user may select to conduct the transaction using a one-time anonymized credit card number, see e.g., 615b. For example, the SOCIAL-REF may utilize a pre-designated anonymized set of card details (see, e.g., “AnonCard1,” “AnonCard2”). As another example, the SOCIAL-REF may generate, e.g., in real-time, a one-time anonymous set of card details to securely complete the purchase transaction (e.g., “Anon It 1X”). In such implementations, the app may automatically set the user profile settings such that the any personal identifying information of the user will not be provided to the merchant and/or other entities. In some implementations, the user may be required to enter a user name and password to enable the anonymization features.

In FIG. 6D, upon purchasing the product in FIG. 6C, the user may publish news feeds with regard to the purchase, and may view his followers' feedbacks. For example, in 6D.(1), the user may select to view the list of feedbacks per update, which may comprise a list of followers feedbacks on the item “Canon SX20IS” in time sequence. In 6D.(2), the user may select view the feedbacks per followers' degrees of separations, e.g., the feedback activities (e.g., “likes,” comments, etc.) are grouped by degree of separations. In 6D.(3), the user may view the feedbacks by activity type, e.g., “likes,” purchases, comments, etc.

With reference to FIG. 6E, in some implementations, the user may be able to view and/or modify the user profile and/or settings of the user, e.g., by activating user interface element 622 (of FIG. 6B). For example, the user may be able to view/modify a user name (e.g., 641a-b), account number (e.g., 642a-b), user security access code (e.g., 643a-b), user pin (e.g., 644a-b), user address (e.g., 645a-b), social security number associated with the user (e.g., 646a-b), current device GPS location (e.g., 647a-b), user account of the merchant in whose store the user currently is (e.g., 648a-b), the user's rewards accounts (e.g., 649a-b), and/or the like. In some implementations, the user may be able to select which of the data fields and their associated values should be transmitted to facilitate the purchase transaction, thus providing enhanced data security for the user. For example, in the example illustration in FIG. 6E, the user has selected the name 641a, account number 642a, security code 643a, merchant account ID 648a and rewards account ID 649a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the SOCIAL-REF with the GPS location of the user. Based on the GPS location of the user, the SOCIAL-REF may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information.

With reference to FIG. 6F, in some implementations, the app executing on the user's device may provide a “VerifyChat” feature for fraud prevention (e.g., by activating UI element 623 in FIG. 6B). For example, the SOCIAL-REF may detect an unusual and/or suspicious transaction. The SOCIAL-REF may utilize the VerifyChat feature to communicate with the user, and verify the authenticity of the originator of the purchase transaction. In various implementations, the SOCIAL-REF may send electronic mail message, text (SMS) messages, Facebook® messages, Twitter™ tweets, text chat, voice chat, video chat (e.g., Apple FaceTime), and/or the like to communicate with the user. For example, the SOCIAL-REF may initiate a video challenge for the user, e.g., 650. For example, the user may need to present him/her-self via a video chat, e.g., 652. In some implementations, a customer service representative, e.g., agent 654b, may manually determine the authenticity of the user using the video of the user. In some implementations, the SOCIAL-REF may utilize face, biometric and/or like recognition (e.g., using pattern classification techniques) to determine the identity of the user, e.g., 654a. In some implementations, the app may provide reference marker (e.g., cross-hairs, target box, etc.), e.g., 653, so that the user may the video to facilitate the SOCIAL-REF's automated recognition of the user. In some implementations, the user may not have initiated the transaction, e.g., the transaction is fraudulent. In such implementations, the user may cancel, e.g., 655, the challenge. The SOCIAL-REF may then cancel the transaction, and/or initiate fraud investigation procedures on behalf of the user.

In some implementations, the SOCIAL-REF may utilize a text challenge procedure to verify the authenticity of the user, e.g., 656. For example, the SOCIAL-REF may communicate with the user via text chat, SMS messages, electronic mail, Facebook® messages, Twitter™ tweets, and/or the like. The SOCIAL-REF may pose a challenge question, e.g., 648, for the user. The app may provide a user input interface element(s) (e.g., virtual keyboard 659) to answer the challenge question posed by the SOCIAL-REF. In some implementations, the challenge question may randomly selected by the SOCIAL-REF automatically; in some implementations, a customer service representative may manually communicate with the user. In some implementations, the user may not have initiated the transaction, e.g., the transaction is fraudulent. In such implementations, the user may cancel, e.g., 657, 660, the text challenge. The SOCIAL-REF may then cancel the transaction, and/or initiate fraud investigation procedures on behalf of the user.

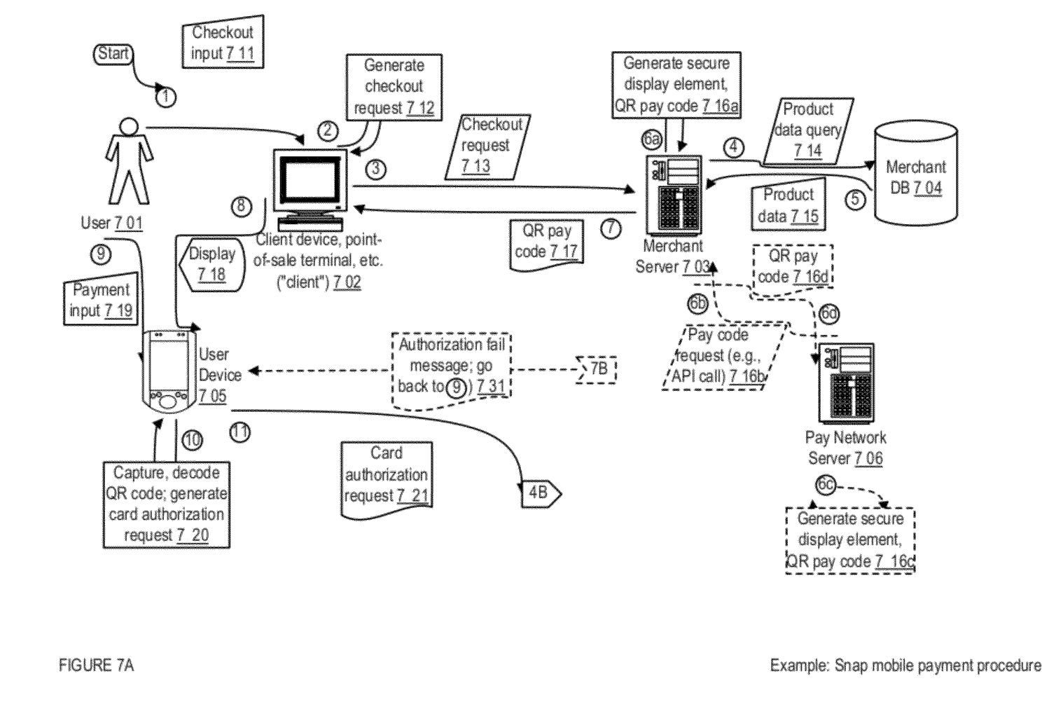

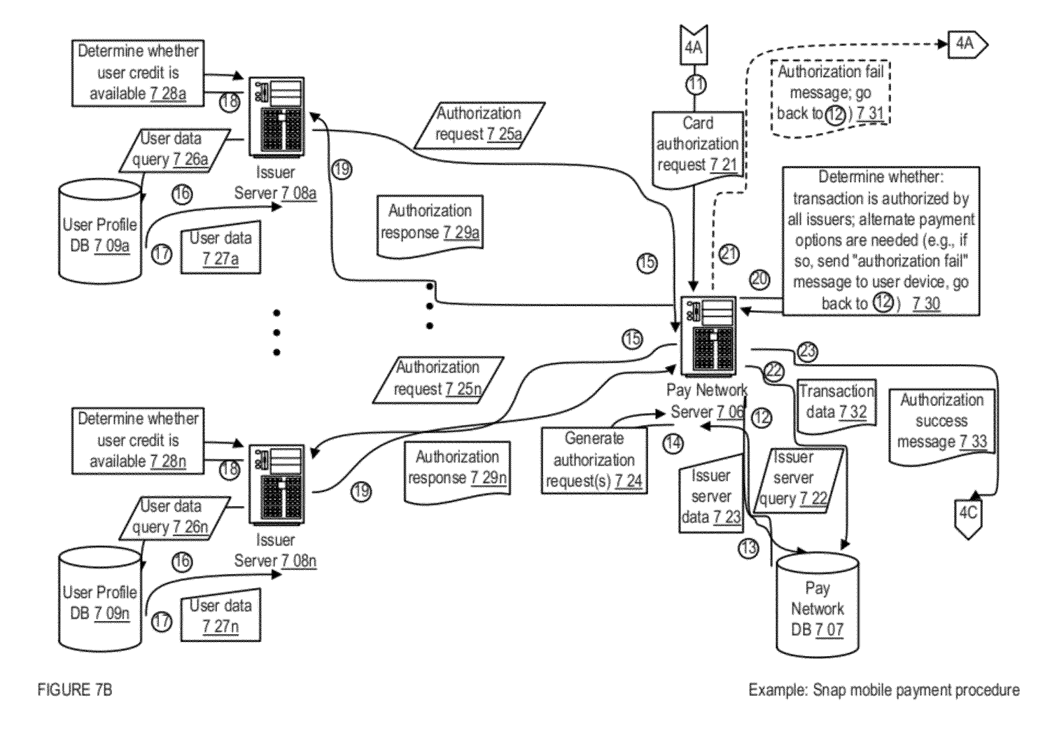

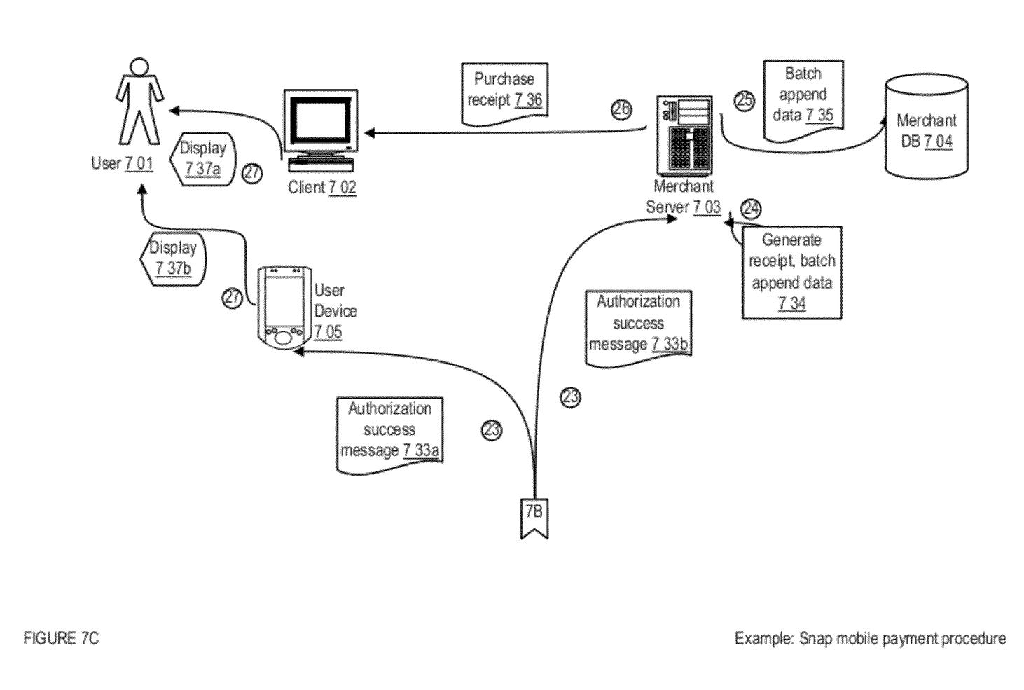

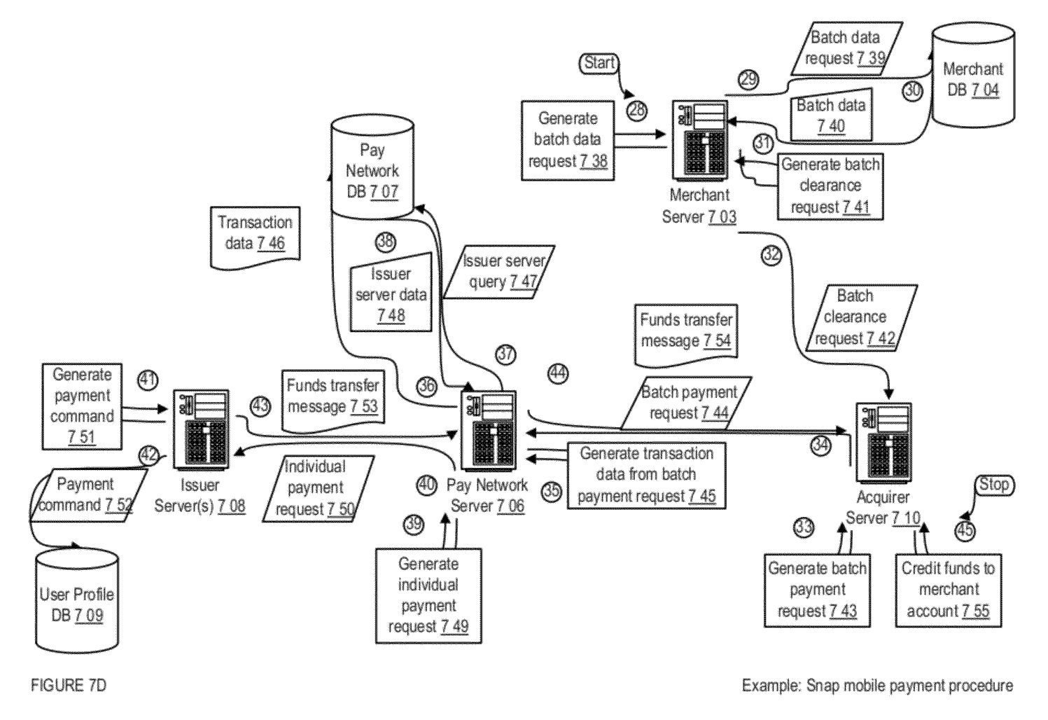

FIGS. 7A-D show data flow diagrams illustrating an example snap mobile payment procedure in some embodiments of the SOCIAL-REF. With reference to FIG. 7A, in some implementations, a user, e.g., 701, may desire to purchase a product, service, offering, and/or the like (“product”), from a merchant, e.g., 703, via a merchant online site or in the merchant's store. The user may communicate with a merchant server, e.g., 703, via a client such as, but not limited to: a personal computer, mobile device, television, point-of-sale terminal, kiosk, ATM, and/or the like (e.g., 702). For example, the user may provide user input, e.g., checkout input 711, into the client indicating the user's desire to purchase the product. For example, a user in a merchant store may scan a product barcode of the product via a barcode scanner at a point-of-sale terminal. As another example, the user may select a product from a webpage catalog on the merchant's website, and add the product to a virtual shopping cart on the merchant's website. The user may then indicate the user's desire to checkout the items in the (virtual) shopping cart. The client may generate a checkout request, e.g., 712, and provide the checkout request, e.g., 713, to the merchant server. For example, the client may provide a (Secure) Hypertext Transfer Protocol (“HTTP(S)”) GET message including the product details for the merchant server in the form of data formatted according to the eXtensible Markup Language (“XML”). Below is an example HTTP(S) GET message including an XML-formatted checkout request for the merchant server:

```
GET /checkout.php HTTP/1.1
Host: www.merchant.com
Content-Type: Application/XML
Content-Length: 718
<?XML version = “1.0” encoding = “UTF-8”?>
<checkout_request>
          <cart_ID>4NFU4RG94</order_ID>
          <timestamp>2011-02-22 15:22:43</timestamp>
          <user_ID>john.q.public@gmail.com</user_ID>
          <client_details>
                <client_IP>192.168.23.126</client_IP>
                <client_type>smartphone</client_type>
                <client_model>HTC Hero</client_model>
                <OS>Android 2.2</OS>
                <app_installed_flag>true</app_installed_flag>
          </client_details>
          <purchase_details>
                <num_products>1</num_products>
                <product>
                      <product_type>book</product_type>
                      <product_params>
                            <product_title>XML for
                            dummies</product_title>
                            <ISBN>938-2-14-168710-0</ISBN>
                            <edition>2nd ed.</edition>
                            <cover>hardbound</cover>
                            <seller>bestbuybooks</seller>
                      </product_params>
                      <quantity>1</quantity>
                </product>
          </purchase_details>
</checkout_request>
```

In some implementations, the merchant server may obtain the checkout request from the client, and extract the checkout detail (e.g., XML data) from the checkout request. For example, the merchant server may utilize a parser such as the example parsers described below in the discussion with reference to FIG. 6. The merchant server may extract the product data, as well as the client data from the checkout request. In some implementations, the merchant server may query, e.g., 714, a merchant database, e.g., 704, to obtain product data, e.g., 715, such as product pricing, sales tax, offers, discounts, rewards, and/or other information to process the purchase transaction. For example, the database may be a relational database responsive to Structured Query Language (“SQL”) commands. The merchant server may execute a hypertext preprocessor (“PHP”) script including SQL commands to query the database for product data. An example PHP/SQL command listing, illustrating substantive aspects of querying the database, is provided below:

<?PHP
header(‘Content-Type: text/plain’);
mysql_connect(“254.93.179.112”,$DBserver,$password); // access
database server
mysql_select_db(“PRODUCTS.SQL”); // select database table to search
//create query
$query = “SELECT product_info product_price
tax_linfo_list offers_list
discounts_list rewards_list FROM ProdTable WHERE product
LIKE ‘%’ $prod”;
$result = mysql_query($query); // perform the search query
mysql_close(“PRODUCTS.SQL”); // close database access
?>

In some implementations, in response to obtaining the product data, the merchant server may generate, e.g., 716a, a QR pay code, and/or secure display element according to the security settings of the user (see, e.g., 358). The merchant server may provide the QR code to the client, so that the client may display the QR code, and the user may capture the QR code using the user's device to obtain merchant and/or product data for generating a purchase transaction processing request. In alternate implementations, the merchant server may direct the client to communicate the product and/or merchant data required to process the transaction to the user's device via an alternate communication protocol, such as, but not limited to: Wi-Fi™, Bluetooth™, cellular network, SMS, email and/or like communication protocols. For example, the merchant server may direct the client to initiate a plug-in on its system to provide the alternate communication service, and transmit the product and/or merchant data to the user's device via the communication service.

In implementations utilizing a QR code, the merchant server may generate a QR code embodying the product information, as well as merchant information required by a payment network to process the purchase transaction. In some implementations, the QR code may include at least information required by the user device capturing the QR code to generate a purchase transaction processing request, such as a merchant identifier (e.g., a merchant ID number, merchant name, store ID, etc.) and a session identifier for a user shopping session associated with the shopping website/brick-and-mortar store.

In alternate implementations, the merchant server may generate in real-time, a custom, user-specific merchant-product XML data structure having a time-limited validity period, such as the example ‘QR_data’ XML data structure provided below:

```
<QR_data>
          <order_ID>4NFU4RG94</order_ID>
          <timestamp>2011-02-22 15:22:43</timestamp>
          <expiry_lapse>00:00:30</expiry_lapse>
          <transaction_cost>$34.78</transaction_cost>
          <alerts_URL>www.merchant.com/shopcarts.php?sessionID=
AEBB4356</alerts_URL>
          <user_ID>john.q.public@gmail.com</user_ID>
          <client_details>
                <client_IP>192.168.23.126</client_IP>
                <client_type>smartphone</client_type>
                <client_model>HTC Hero</client_model>
                <OS>Android 2.2</OS>
                <app_installed_flag>true</app_installed_flag>
          </client_details>
          <secure_element>www.merchant.com/securedyn/0394733/
123.png</secure_element>
          <purchase_details>
                <num_products>1</num_products>
                <product>
                      <product_type>book</product_type>
                      <product_params>
                              <product_title>XML for
                              dummies</product_title>
                              <ISBN>938-2-14-168710-0</ISBN>
                              <edition>2nd ed.</edition>
                              <cover>hardbound</cover>
                              <seller>bestbuybooks</seller>
                      </product_params>
                      <quantity>1</quantity>
                </product>
          </purchase_details>
          <merchant_params>
                <merchant_id>3FBCR4INC</merchant_id>
                <merchant_name>Books & Things,
                Inc.</merchant_name>
                <merchant_auth_key>
                1NNF484MCP59CHB27365</merchant_auth_key>
          </merchant_params>
<QR_data>
```

In some implementations, the XML data may include a handle, alias, token, or pointer to information stored on a payment network server, rather than encoding all of the actual data required to initiate the transaction, so that the information encoded into the QR code may be advantageously minimized. In some implementations, the merchant may generate a QR code using the XML data. For example, the merchant server may utilize the PHP QR Code open-source (LGPL) library for generating QR Code, 2-dimensional barcode, available at http://phpqrcode.sourceforge.net/. For example, the merchant server may issue PHP commands similar to the example commands provided below:

<?PHP
header(‘Content-Type: text/plain’);
// Create QR code image using data stored in $data variable
QRcode::png($data, ‘qrcodeimg.png’);
?>

In alternate implementations, the merchant server may provide, e.g., 716b the XML data to a pay network server, e.g., 706, along with a request to generate a QR code. For example, the merchant server may utilize an API call to the pay network server to request generation of the QR code. The pay network server may generate the QR code for the merchant server, e.g., 716c, and provide, e.g., 716d, the QR code to the merchant server. For example, the pay network server may encode the information provided by the merchant into the QR code, and may also advantageously encode security information, time validity information, digital certificate information, anonymous shipping information, QR code generation/processing fee information, etc. into the QR code.

In some implementations, the merchant server may provide the QR pay code to the client, e.g., 717. For example, the merchant server may provide a HyperText Markup Language (“HTML”) page including a reference to the QR code image and/or secure element image, such as the example HTML page below:

```
<html>
          <img src=“www.merchant.com/securedyn/0394733/
qrcodeimg.png” alt=”Merchant-Product QR code”/>
          <img src=“ www.merchant.com/securedyn/0394733/123.png”
alt=”Secure Element”/>
</html>
```

In some implementations, the client may obtain the QR pay code, e.g., 717, and display the QR code, e.g., 718 on a display screen associated with the client device. In some implementations, the user may utilize a user device, e.g., 705, to capture the QR code presented by the client device for payment processing. For example, the user may provide payment input into the user device, e.g., 719. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. For example, the user device may obtain track 1 data from the user's card (e.g., credit card, debit card, prepaid card, charge card, etc.), such as the example track 1 data provided below:

%B123456789012345\hat{ }PUBLIC/
J.Q.\hat{ }99011200000000000000**901******?* (wherein
‘123456789012345’ is the card number of ‘J.Q. Public’ and
has a CVV number of 901. ‘990112’ is a service code, and *** represents
decimal digits which change randomly each time the card is used.)

In some implementations, upon obtaining the user payment input and capturing the QR code, the user device may generate a card authorization request, e.g., 720. For example, the user device may provide a card authorization request, e.g., 721, on behalf of the user, a HTTP(S) GET message including the product order details for a pay network server, e.g., 706, in the form of XML-formatted data. Below is an example HTTP(S) GET message including an XML-formatted card authorization request for the pay network server:

```
GET /purchase.php HTTP/1.1
Host: www.merchant.com
Content-Type: Application/XML
Content-Length: 1306
<?XML version = “1.0” encoding = “UTF-8”?>
<purchase_order>
          <order_ID>4NFU4RG94</order_ID>
          <alerts_URL>www.merchant.com/shopcarts.php?sessionID=AEBB4356</alerts_URL>
          <timestamp>2011-02-22 15:22:43</timestamp>
          <user_ID>john.q.public@gmail.com</user_ID>
          <client_details>
                <client_IP>192.168.23.126</client_IP>
                <client_type>smartphone</client_type>
                <client_model>HTC Hero</client_model>
                <OS>Android 2.2</OS>
                <app_installed_flag>true</app_installed_flag>
          </client_details>
          <purchase_details>
                <num_products>1</num_products>
                <product>
                      <product_type>book</product_type>
                      <product_params>
                            <product_title>XML for dummies</product_title>
                            <ISBN>938-2-14-168710-0</ISBN>
                            <edition>2nd ed.</edition>
                            <cover>hardbound</cover>
                            <seller>bestbuybooks</seller>
                      </product_params>
                      <quantity>1</quantity>
                </product>
          </purchase_details>
          <merchant_params>
                <merchant_id>3FBCR4INC</merchant_id>
                <merchant_name>Books & Things, Inc.</merchant_name>
                <merchant_auth_key>1NNF484MCP59CHB27365</merchant_auth_key>
          </merchant_params>
          <account_params>
                <account_name>John Q. Public</account_name>
                <account_type>credit</account_type>
                <account_num>123456789012345</account_num>
                <billing_address>123 Green St., Norman, OK
98765</billing_address>
                <phone>123-456-7809</phone>
                <sign>/jqp/</sign>
                <confirm_type>email</confirm_type>
                <contact_info>john.q.public@gmail.com</contact_info>
          </account_params>
          <shipping_info>
                <shipping_adress>same as billing</shipping_address>
                <ship_type>expedited</ship_type>
                <ship_carrier>FedEx</ship_carrier>
                <ship_account>123-45-678</ship_account>
                <tracking_flag>true</tracking_flag>
                <sign_flag>false</sign_flag>
          </shipping_info>
</purchase_order>
```

In some implementations, the card authorization request generated by the user device may include a minimum of information required to process the purchase transaction. For example, this may improve the efficiency of communicating the purchase transaction request, and may also advantageously improve the privacy protections provided to the user and/or merchant. For example, in some implementations, the card authorization request may include at least a merchant ID, a session ID for the user's shopping session with the merchant, and a device ID of a device (e.g., smartphone) of the user that is linked to the user's virtual wallet. In some implementations, the QR code and messages sent to/from the QR-code capturing device may include the source ID (e.g., identifier of the device generating the QR code), session ID, merchant ID, item ID (e.g., model number), the charge amount, and/or transacting device ID (e.g., the user's smartphone device).

With reference to FIG. 7B, in some implementations, the pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer.

In some implementations, the pay network server may generate a query, e.g., 722, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s), e.g., 708a-n, of the issuer(s) may maintain details of the user's account. In some implementations, a database, e.g., pay network database 707, may store details of the issuer server(s) associated with the issuer(s). For example, the database may be a relational database responsive to Structured Query Language (“SQL”) commands. The pay network server may query the pay network database for issuer server(s) details. For example, the pay network server may execute a hypertext preprocessor (“PHP”) script including SQL commands to query the database for details of the issuer server(s). An example PHP/SQL command listing, illustrating substantive aspects of querying the database, is provided below:

<?PHP
header(‘Content-Type: text/plain’);
mysql_connect(“254.93.179.112”,$DBserver,$password); // access
database server mysql_select_db(“ISSUERS.SQL”); // select database
table to search //create query for issuer server data $query = “SELECT
issuer_name issuer_address issuer_id ip_address mac_address
auth_key port_num security_settings_list FROM IssuerTable
WHERE account_num LIKE ‘%’ $accountnum”; $result =
mysql_query($query); // perform the search query
mysql_close(“ISSUERS.SQL”); // close database access
?>

In response to obtaining the issuer server query, e.g., 722, the pay network database may provide, e.g., 723, the requested issuer server data to the pay network server. In some implementations, the pay network server may utilize the issuer server data to generate authorization request(s), e.g., 724, for each of the issuer server(s) selected based on the pre-defined payment settings associated with the user's virtual wallet, and/or the user's payment options input, and provide the card authorization request(s), e.g., 725a-n, to the issuer server(s), e.g., 708a-n. In some implementations, the authorization request(s) may include details such as, but not limited to: the costs to the user involved in the transaction, card account details of the user, user billing and/or shipping information, and/or the like. For example, the pay network server may provide a HTTP(S) POST message including an XML-formatted authorization request similar to the example listing provided below:

```
POST /authorization.php HTTP/1.1
Host: www.issuer.com
Content-Type: Application/XML
Content-Length: 624
<?XML version = “1.0” encoding = “UTF-8”?>
<card_query_request>
          <query_ID>VNEI39FK</query_ID>
          <timestamp>2011-02-22 15:22:44</timestamp>
          <purchase_summary>
                <num_products>1</num_products>
                <product>
                      <product_summary>Book - XML for
dummies</product_summary>
                      <product_quantity>1</product_quantity?
                </product>
          </purchase_summary>
          <transaction_cost>$22.61</transaction_cost>
          <account_params>
                <account_type>checking</account_type>
                <account_num>1234567890123456</account_num>
          </account_params>
          <merchant_params>
                <merchant_id>3FBCR4INC</merchant_id>
                <merchant_name>Books & Things, Inc.</merchant_name>
                <merchant_auth_key>1NNF484MCP59CHB27365</merchant_auth_key>
          </merchant_params>
</card_query_request>
```

In some implementations, an issuer server may parse the authorization request(s), and based on the request details may query a database, e.g., user profile database 709a-n, for data associated with an account linked to the user. For example, the issuer server may issue PHP/SQL commands similar to the example provided below:

<?PHP
header(‘Content-Type: text/plain’);
mysql_connect(“254.93.179.112”,$DBserver,$password); // access
database server mysql_select_db(“USERS.SQL”); // select database
table to search //create query for user data $query = “SELECT user_id
user_name user_balance account_type FROM UserTable WHERE
account_num LIKE ‘%’ $accountnum”; $result = mysql_query($query);
// perform the search query mysql_close(“USERS.SQL”); // close
database access
?>

In some implementations, on obtaining the user data, e.g., 727a-n, the issuer server may determine whether the user can pay for the transaction using funds available in the account, e.g., 728a-n. For example, the issuer server may determine whether the user has a sufficient balance remaining in the account, sufficient credit associated with the account, and/or the like. Based on the determination, the issuer server(s) may provide an authorization response, e.g., 729a-n, to the pay network server. For example, the issuer server(s) may provide a HTTP(S) POST message similar to the examples above. In some implementations, if at least one issuer server determines that the user cannot pay for the transaction using the funds available in the account, see e.g., 730-431, the pay network server may request payment options again from the user (e.g., by providing an authorization fail message 731 to the user device and requesting the user device to provide new payment options), and re-attempt authorization for the purchase transaction. In some implementations, if the number of failed authorization attempts exceeds a threshold, the pay network server may abort the authorization process, and provide an “authorization fail” message to the merchant server, user device and/or client.

With reference to FIG. 7C, in some implementations, the pay network server may obtain the authorization message including a notification of successful authorization, see e.g., 730, 733, and parse the message to extract authorization details. Upon determining that the user possesses sufficient funds for the transaction, the pay network server may generate a transaction data record, e.g., 732, from the authorization request and/or authorization response, and store the details of the transaction and authorization relating to the transaction in a transactions database. For example, the pay network server may issue PHP/SQL commands similar to the example listing below to store the transaction data in a database:

<?PHP
header(‘Content-Type: text/plain’);
mysql_connect(“254.92.185.103”,$DBserver,$password); // access
database server mysql_select(“TRANSACTIONS.SQL”); // select
database to append mysql_query(“INSERT INTO PurchasesTable
(timestamp, purchase_summary_list, num_products, product_summary,
product_quantity, transaction_cost, account_params_list,
account_name, account_type, account_num, billing_addres,
zipcode, phone, sign, merchant_params_list, merchant_id,
merchant_name, merchant_auth_key) VALUES (time( ),
$purchase_summary_list, $num_products, $product_summary,
$product_quantity, $transaction_cost, $account_params_list,
$account_name, $account_type, $account_num, $billing_addres,
$zipcode, $phone, $sign, $merchant_params_list, $merchant_id,
$merchant_name, $merchant_auth_key)”); // add data to table
in database mysql_close(“TRANSACTIONS.SQL”); // close connection
to database
?>

In some implementations, the pay network server may forward an authorization success message, e.g., 733a-b, to the user device and/or merchant server. The merchant may obtain the authorization message, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 734, and store the XML data file, e.g., 735, in a database, e.g., merchant database 704. For example, a batch XML data file may be structured similar to the example XML data structure template provided below:

```
<?XML version = “1.0” encoding = “UTF-8”?>
<merchant_data>
          <merchant_id>3FBCR4INC</merchant_id>
          <merchant_name>Books & Things, Inc.</merchant_name>
          <merchant_auth_key>1NNF484MCF59CHB27365
          </merchant_auth_key>
          <account_number>123456789</account_number>
</merchant_data>
<transaction_data>
          <transaction 1>
                ...
          </transaction 1>
          <transaction 2>
                ...
          </transaction 2>
                .
                .
                .
          <transaction n>
                ...
          </transaction n>
</transaction_data>
```

In some implementations, the server may also generate a purchase receipt, e.g., 734, and provide the purchase receipt to the client, e.g., 736. The client may render and display, e.g., 737a, the purchase receipt for the user. In some implementations, the user device 705 may also provide a notification of successful authorization to the user, e.g., 737b. For example, the client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

With reference to FIG. 7D, in some implementations, the merchant server may initiate clearance of a batch of authorized transactions. For example, the merchant server may generate a batch data request, e.g., 738, and provide the request, e.g., 739, to a database, e.g., merchant database 704. For example, the merchant server may utilize PHP/SQL commands similar to the examples provided above to query a relational database. In response to the batch data request, the database may provide the requested batch data, e.g., 740. The server may generate a batch clearance request, e.g., 741, using the batch data obtained from the database, and provide, e.g., 742, the batch clearance request to an acquirer server, e.g., 710. For example, the merchant server may provide a HTTP(S) POST message including XML-formatted batch data in the message body for the acquirer server. The acquirer server may generate, e.g., 743, a batch payment request using the obtained batch clearance request, and provide the batch payment request to the pay network server, e.g., 744. The pay network server may parse the batch payment request, and extract the transaction data for each transaction stored in the batch payment request, e.g., 745. The pay network server may store the transaction data, e.g., 746, for each transaction in a database, e.g., pay network database 707. For each extracted transaction, the pay network server may query, e.g., 747-448, a database, e.g., pay network database 707, for an address of an issuer server. For example, the pay network server may utilize PHP/SQL commands similar to the examples provided above. The pay network server may generate an individual payment request, e.g., 749, for each transaction for which it has extracted transaction data, and provide the individual payment request, e.g., 750, to the issuer server, e.g., 708. For further implementations, the individual payment request may be triggered by referral fee payment request (e.g., see FIG. 1B). For example, the pay network server may provide a HTTP(S) POST request similar to the example below:

```
POST /requestpay.php HTTP/1.1
Host: www.issuer.com
Content-Type: Application/XML
Content-Length: 788
<?XML version = “1.0” encoding = “UTF-8”?>
<pay_request>
          <request_ID>CNI4ICNW2</request_ID>
          <timestamp>2011-02-22 17:00:01</timestamp>
          <pay_amount>$34.78</pay_amount>
          <account_params>
                <account_name>John Q. Public</account_name>
                <account_type>credit</account_type>
                <account_num>123456789012345</account_num>
                <billing_address>123 Green St., Norman, OK
98765</billing_address>
                <phone>123-456-7809</phone>
                <sign>/jqp/</sign>
          </account_params>
          <merchant_params>
                <merchant_id>3FBCR4INC</merchant_id>
                <merchant_name>Books & Things, Inc.</merchant_name>
                <merchant_auth_key>1NNF484MCP59CHB27365</merchant_auth_key>
          </merchant_params>
          <purchase_summary>
                <num_products>1</num_products>
                <product>
                      <product_summary>Book - XML for
dummies</product_summary>
                      <product_quantity>1</product_quantity?
                </product>
          </purchase_summary>
</pay_request>
```

In some implementations, the issuer server may generate a payment command, e.g., 751. For example, the issuer server may issue a command to deduct funds from the user's account (or add a charge to the user's credit card account). The issuer server may issue a payment command, e.g., 752, to a database storing the user's account information, e.g., user profile database 709. The issuer server may provide a funds transfer message, e.g., 753, to the pay network server, which may forward, e.g., 754, the funds transfer message to the acquirer server. An example HTTP(S) POST funds transfer message is provided below:

```
POST /clearance.php HTTP/1.1
Host: www.acquirer.com
Content-Type: Application/XML
Content-Length: 206
<?XML version = “1.0” encoding = “UTF-8”?>
<deposit_ack>
          <request_ID>CNI4ICNW2</request_ID>
          <clear_flag>true</clear_flag>
          <timestamp>2011-02-22 17:00:02</timestamp>
          <deposit_amount>$34.78</deposit_amount>
</deposit_ack>
```

In some implementations, the acquirer server may parse the funds transfer message, and correlate the transaction (e.g., using the request ID field in the example above) to the merchant. The acquirer server may then transfer the funds specified in the funds transfer message to an account of the merchant, e.g., 755.

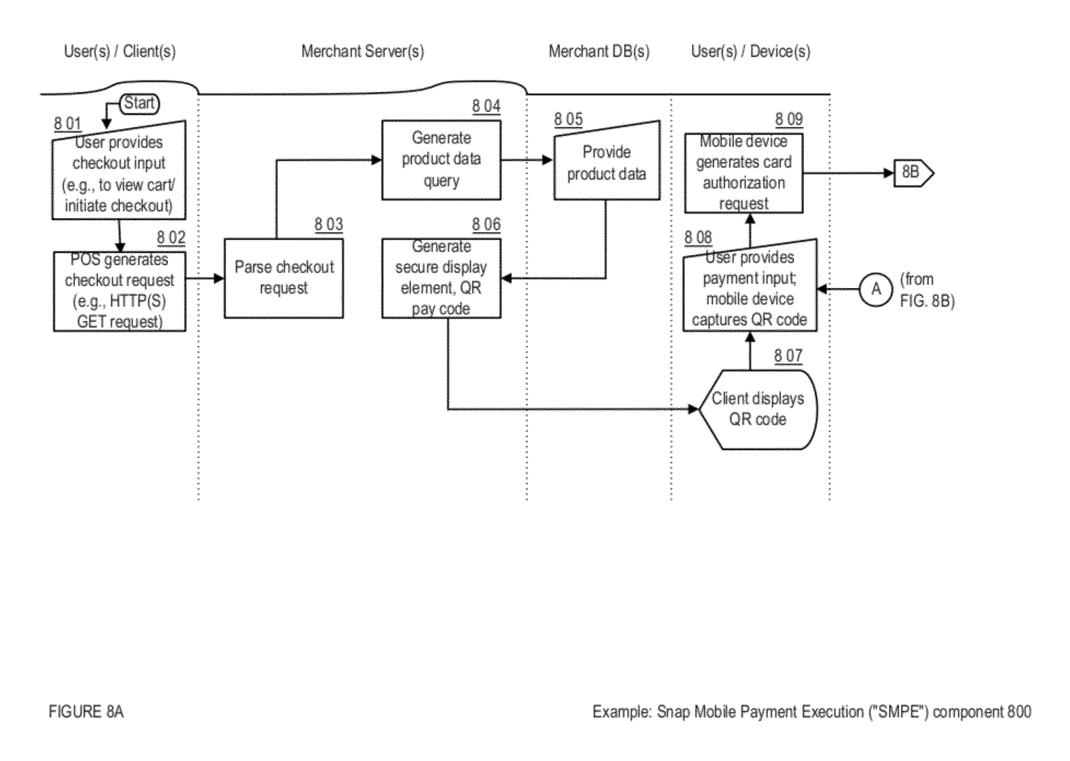

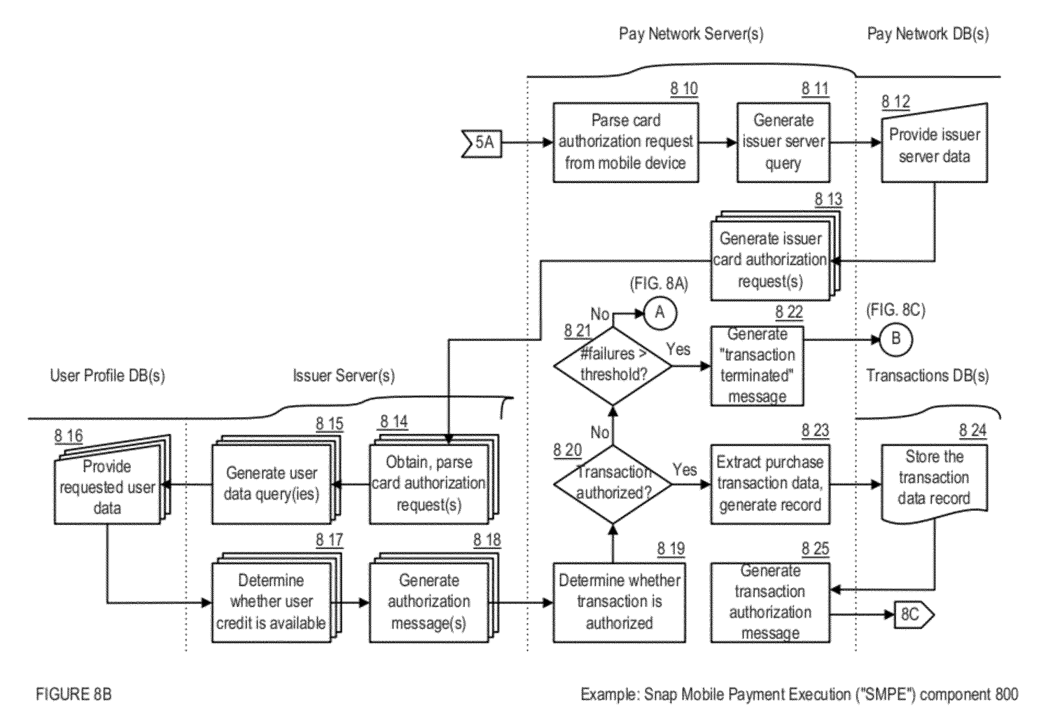

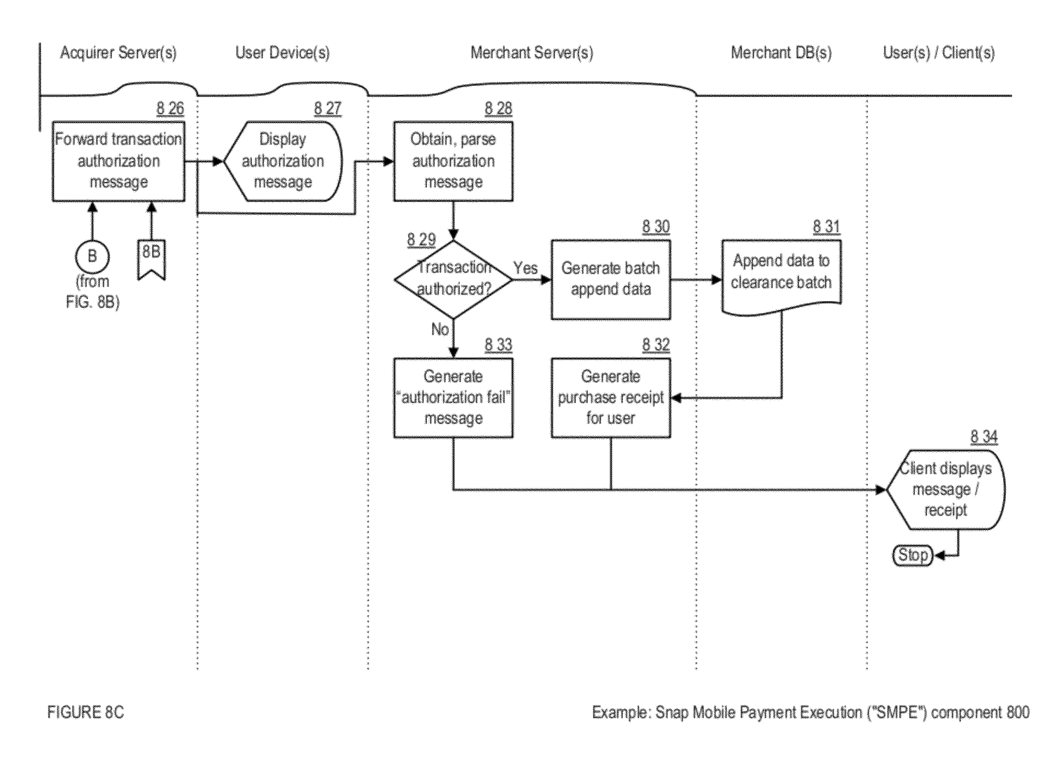

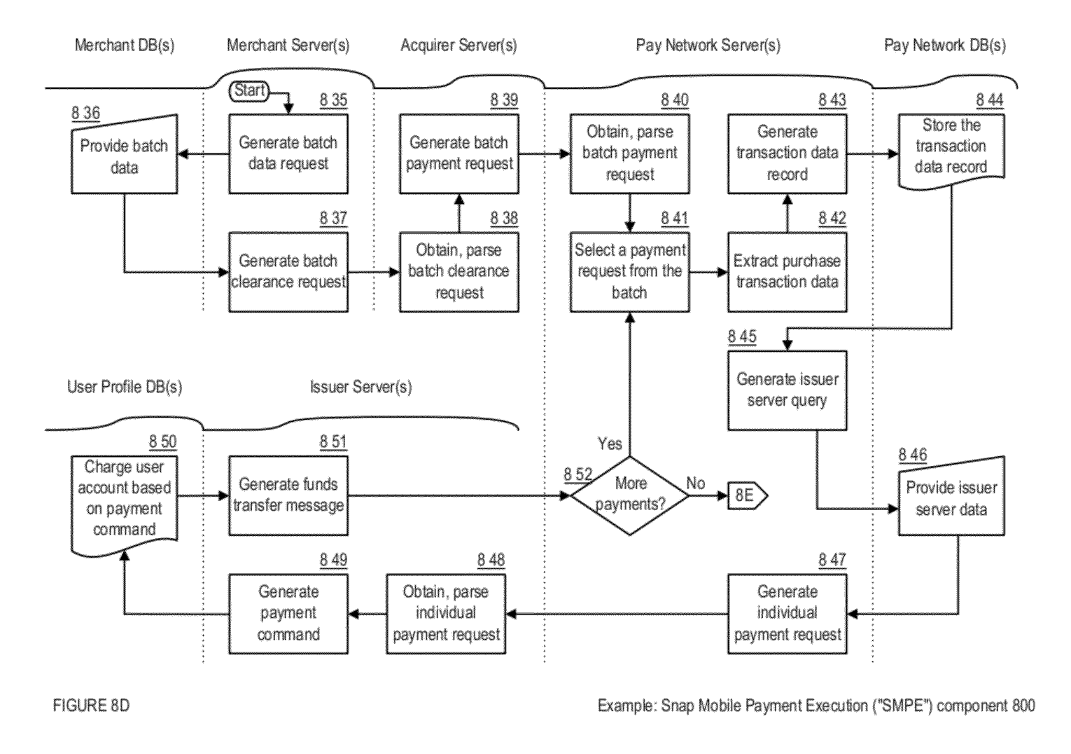

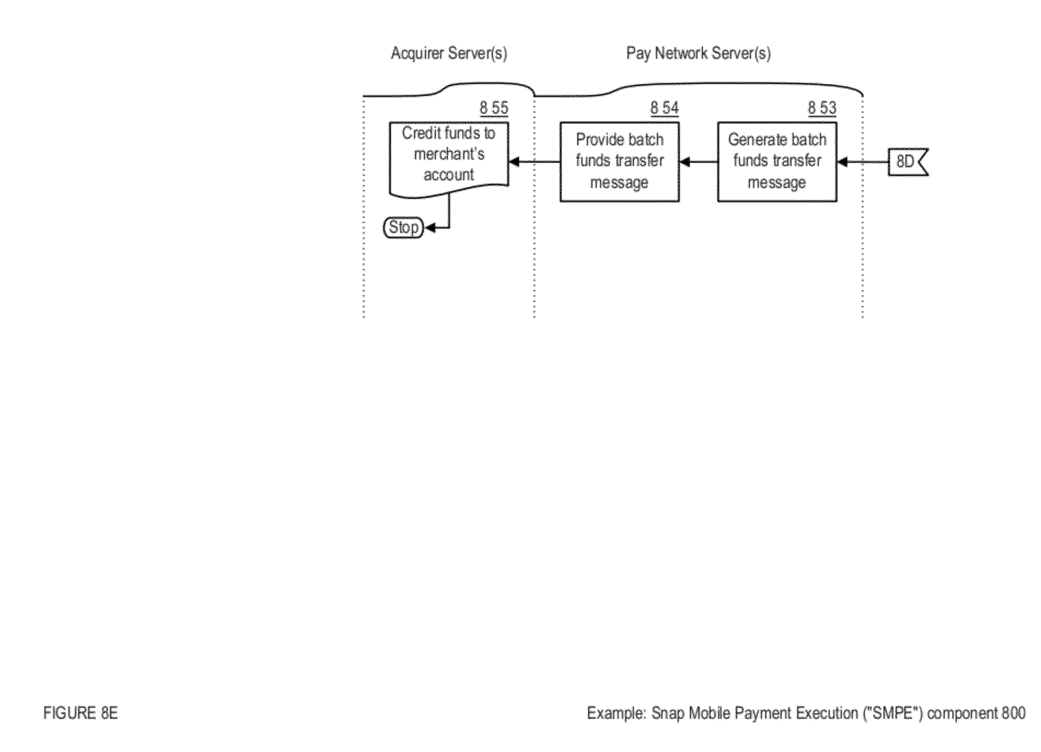

FIGS. 8A-E show logic flow diagrams illustrating example aspects of executing a snap mobile payment in some embodiments of the SOCIAL-REF, e.g., a Snap Mobile Payment Execution (“SMPE”) component 800. With reference to FIG. 138A, in some implementations, a user may desire to purchase a product, service, offering, and/or the like (“product”), from a merchant via a merchant online site or in the merchant's store. The user may communicate with a merchant server via a client. For example, the user may provide user input, e.g., 801, into the client indicating the user's desire to checkout shopping items in a (virtual) shopping cart. The client may generate a checkout request, e.g., 802, and provide the checkout request to the merchant server. The merchant server may obtain the checkout request from the client, and extract the checkout detail (e.g., XML data) from the checkout request, e.g., 803. The merchant server may extract the product data, as well as the client data from the checkout request. In some implementations, the merchant server may query, e.g., 804, a merchant database to obtain product data, e.g., 805, such as product pricing, sales tax, offers, discounts, rewards, and/or other information to process the purchase transaction.

In response to obtaining the product data, the merchant server may generate, e.g., 806, a QR pay code, and/or secure display element according to the security settings of the user (see, e.g., 658). For example, the merchant server may generate a QR code embodying the product information, as well as merchant information required by a payment network to process the purchase transaction. For example, the merchant server may first generate in real-time, a custom, user-specific merchant-product XML data structure having a time-limited validity period, such as the example ‘QR_data’ XML data structure provided below:

```
<QR_data>
          <order_ID>4NFU4RG94</order_ID>
          <timestamp>2011-02-22 15:22:43</timestamp>
          <expiry_lapse>00:00:30</expiry_lapse>
          <transaction_cost>$34.78</transaction_cost>
          <user_ID>john.q.public@gmail.com</user_ID>
          <client_details>
                <client_IP>192.168.23.126</client_IP>
                <client_type>smartphone</client_type>
                <client_model>HTC Hero</client_model>
                <OS>Android 2.2</OS>
                <app_installed_flag>true</app_installed_flag>
          </client_details>
          <secure_element>www.merchant.com/securedyn/0394733/123.png</secure_element>
          <purchase_details>
                <num_products>1</num_products>
                <product>
                      <product_type>book</product_type>
                      <product_params>
                            <product_title>XML for dummies</product_title>
                            <ISBN>938-2-14-168710-0</ISBN>
                            <edition>2nd ed.</edition>
                            <cover>hardbound</cover>
                            <seller>bestbuybooks</seller>
                      </product_params>
                      <quantity>1</quantity>
                </product>
          </purchase_details>
          <merchant_params>
                <merchant_id>3FBCR4INC</merchant_id>
                <merchant_name>Books & Things, Inc.</merchant_name>
                <merchant_auth_key>1NNF484MCP59CHB27365</merchant_auth_key>
          </merchant_params>
<QR_data>
```

In some implementations, the merchant may generate QR code using the XML data. For example, the merchant server may utilize the PHP QR Code open-source (LGPL) library for generating QR Code, 2-dimensional barcode, available at http://phpqrcode.sourceforge.net/. For example, the merchant server may issue PHP commands similar to the example commands provided below:

<?PHP
header(‘Content-Type: text/plain’);
// Create QR code image using data stored in $data variable
QRcode::png($data, ‘qrcodeimg.png’);
?>

The merchant server may provide the QR pay code to the client, e.g., 806. The client may obtain the QR pay code, and display the QR code, e.g., 807 on a display screen associated with the client device. In some implementations, the user may utilize a user device, e.g., 809, to capture the QR code presented by the client device for payment processing. For example, the user may provide payment input into the user device, e.g., 808. Upon obtaining the user purchase input, the user device may generate a card authorization request, e.g., 809, and provide the card authorization request to a pay network server.

With reference to FIG. 8B, in some implementations, the pay network server may parse the card authorization request, e.g., 810, and generate a query, e.g., 811, for issuer server(s) corresponding to the user-selected payment options. In some implementations, a pay network database may store details of the issuer server(s) associated with the issuer(s). In response to obtaining the issuer server query, the pay network database may provide, e.g., 812, the requested issuer server data to the pay network server. In some implementations, the pay network server may utilize the issuer server data to generate authorization request(s), e.g., 425134, for each of the issuer server(s), and provide the card authorization request(s) to the issuer server(s).

In some implementations, an issuer server may parse the authorization request(s), and based on the request details may query a user profile database for data associated with an account linked to the user. In some implementations, on obtaining the user data, the issuer server may determine whether the user can pay for the transaction using funds available in the account, e.g., 817. For example, the issuer server may determine whether the user has a sufficient balance remaining in the account, sufficient credit associated with the account, and/or the like. Based on the determination, the issuer server(s) may provide an authorization response, e.g., 818, to the pay network server. In some implementations, if at least one issuer server determines, e.g., 819, that the user cannot pay for the transaction using the funds available in the account, see e.g., 82o, option “No,” the pay network server may request payment options again from the user (see e.g., 821, option “No,” by providing an authorization fail message to the user device and requesting the user device to provide new payment options), and re-attempt authorization for the purchase transaction. In some implementations, if the number of failed authorization attempts exceeds a threshold, see, e.g., 821, option “Yes,” the pay network server may abort the authorization process, and provide an “authorization fail” message to the merchant server, user device and/or client, e.g., 822.

In some implementations, the pay network server may obtain the authorization message including a notification of successful authorization, see e.g., 820, option “Yes,”, and parse the message to extract authorization details. Upon determining that the user possesses sufficient funds for the transaction, the pay network server may generate a transaction data record, e.g., 823, from the authorization request and/or authorization response, and store, e.g., 824, the details of the transaction and authorization relating to the transaction in a transactions database.

With reference to FIG. 8C, in some implementations, the pay network server may forward an authorization success message, e.g., 825, to the user device and/or merchant server, sometimes via the acquirer server, e.g. 826. The merchant may parse the authorization message, e.g., 828, and determine from it that the user possesses sufficient funds in the card account to conduct the transaction, see, e.g., 829. The merchant server may add a record of the transaction for the user to a batch of transaction data relating to authorized transactions, see, e.g., 830-531. In some implementations, the merchant server may also generate a purchase receipt, e.g., 832, and provide the purchase receipt to the client. The client may render and display, e.g., 834, the purchase receipt for the user. In some implementations, the user device 405 may also provide a notification of successful authorization to the user.

With reference to FIGS. 8D-E, in some implementations, the merchant server may initiate clearance of a batch of authorized transactions. For example, the merchant server may generate a batch data request, e.g., 835, and provide the request, e.g., 836, to a database, e.g., merchant database. In response to the batch data request, the database may provide the requested batch data, e.g., 836. The server may generate a batch clearance request, e.g., 837, using the batch data obtained from the database, and provide the batch clearance request to an acquirer server. The acquirer server may generate, e.g., 839, a batch payment request using the obtained batch clearance request, and provide the batch payment request to the pay network server. The pay network server may parse the batch payment request, and extract the transaction data for each transaction stored in the batch payment request, e.g., 840-542. The pay network server may store the transaction data, e.g., 843-544, for each transaction in a database, e.g., pay network database. For each extracted transaction, the pay network server may query, e.g., 845-546, a database, e.g., pay network database, for an address of an issuer server. The pay network server may generate an individual payment request, e.g., 847, for each transaction for which it has extracted transaction data, and provide the individual payment request to the associated issuer server.

In some implementations, the issuer server may generate a payment command, e.g., 848-549. For example, the issuer server may issue a command to deduct funds from the user's account (or add a charge to the user's credit card account). The issuer server may issue a payment command, e.g., 849, to a database storing the user's account information, e.g., user profile database. The issuer server may provide a funds transfer message, e.g., 851, to the pay network server, which may forward the funds transfer message to the acquirer server. In some implementations, the acquirer server may parse the funds transfer message, and correlate the transaction (e.g., using the request ID field in the example above) to the merchant. The acquirer server may then transfer the funds specified in the funds transfer message to an account of the merchant, e.g., 853-855.

### SOCIAL-REF Controller

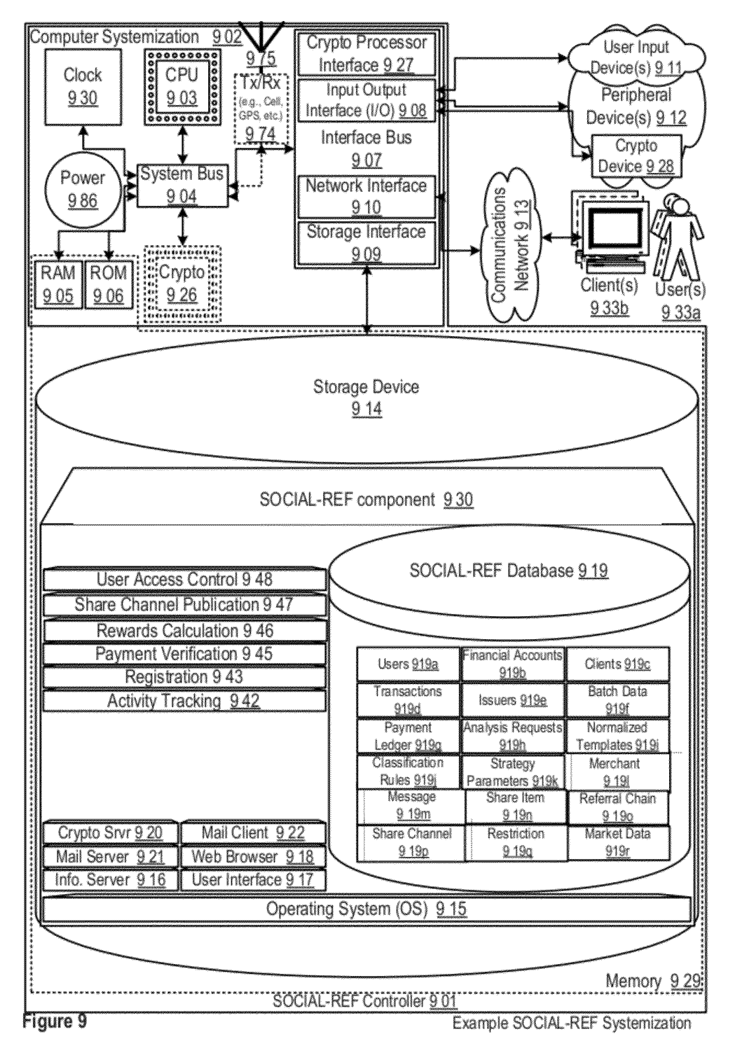

FIG. 9 shows a block diagram illustrating embodiments of a SOCIAL-REF controller. In this embodiment, the SOCIAL-REF controller 901 may serve to aggregate, process, store, search, serve, identify, instruct, generate, match, and/or facilitate interactions with a computer through social network and electronic commerce technologies, and/or other related data.

Typically, users, which may be people and/or other systems, may engage information technology systems (e.g., computers) to facilitate information processing. In turn, computers employ processors to process information; such processors 903 may be referred to as central processing units (CPU). One form of processor is referred to as a microprocessor. CPUs use communicative circuits to carry and pass encoded (e.g., binary) signals acting as instructions to bring about various operations. These instructions may be operational and/or data instructions containing and/or referencing other instructions and data in various processor accessible and operable areas of memory 929 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SOCIAL-REF controller 901 may be connected to and/or communicate with entities such as, but not limited to: one or more users from user input devices 911; peripheral devices 912; an optional cryptographic processor device 928; and/or a communications network 913.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The SOCIAL-REF controller 901 may be based on computer systems that may comprise, but are not limited to, components such as: a computer systemization 902 connected to memory 929.

### Computer Systemization

A computer systemization 902 may comprise a clock 930, central processing unit (“CPU(s)” and/or “processor(s)” (these terms are used interchangeable throughout the disclosure unless noted to the contrary)) 903, a memory 929 (e.g., a read only memory (ROM) 906, a random access memory (RAM) 905, etc.), and/or an interface bus 907, and most frequently, although not necessarily, are all interconnected and/or communicating through a system bus 904 on one or more (mother)board(s) 902 having conductive and/or otherwise transportive circuit pathways through which instructions (e.g., binary encoded signals) may travel to effectuate communications, operations, storage, etc. The computer systemization may be connected to a power source 986; e.g., optionally the power source may be internal. Optionally, a cryptographic processor 926 and/or transceivers (e.g., ICs) 974 may be connected to the system bus. In another embodiment, the cryptographic processor and/or transceivers may be connected as either internal and/or external peripheral devices 912 via the interface bus I/O. In turn, the transceivers may be connected to antenna(s) 975, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing SOCIAL-REF controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 929 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the SOCIAL-REF controller and beyond through various interfaces. Should processing requirements dictate a greater amount speed and/or capacity, distributed processors (e.g., Distributed SOCIAL-REF), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the SOCIAL-REF may be achieved by implementing a microcontroller such as CAST's R8051XC2 microcontroller; Intel's MCS 51 (i.e., 8051 microcontroller); and/or the like. Also, to implement certain features of the SOCIAL-REF, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SOCIAL-REF component collection (distributed or otherwise) and/or features may be implemented via the microprocessor and/or via embedded components; e.g., via ASIC, coprocessor, DSP, FPGA, and/or the like. Alternately, some implementations of the SOCIAL-REF may be implemented with embedded components that are configured and used to achieve a variety of features or signal processing.

Depending on the particular implementation, the embedded components may include software solutions, hardware solutions, and/or some combination of both hardware/software solutions. For example, SOCIAL-REF features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the SOCIAL-REF features. A hierarchy of programmable interconnects allow logic blocks to be interconnected as needed by the SOCIAL-REF system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the SOCIAL-REF may be developed on regular FPGAs and then migrated into a fixed version that more resembles ASIC implementations. Alternate or coordinating implementations may migrate SOCIAL-REF controller features to a final ASIC instead of or in addition to FPGAs. Depending on the implementation all of the aforementioned embedded components and microprocessors may be considered the “CPU” and/or “processor” for the SOCIAL-REF.

### Power Source

The power source 986 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 986 is connected to at least one of the interconnected subsequent components of the SOCIAL-REF thereby providing an electric current to all subsequent components. In one example, the power source 986 is connected to the system bus component 904. In an alternative embodiment, an outside power source 986 is provided through a connection across the I/O 908 interface. For example, a USB and/or IEEE 1394 connection carries both data and power across the connection and is therefore a suitable source of power.

### Interface Adapters

Interface bus(ses) 907 may accept, connect, and/or communicate to a number of interface adapters, conventionally although not necessarily in the form of adapter cards, such as but not limited to: input output interfaces (I/O) 908, storage interfaces 909, network interfaces 910, and/or the like. Optionally, cryptographic processor interfaces 927 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 909 may accept, communicate, and/or connect to a number of storage devices such as, but not limited to: storage devices 914, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 910 may accept, communicate, and/or connect to a communications network 913. Through a communications network 913, the SOCIAL-REF controller is accessible through remote clients 933b (e.g., computers with web browsers) by users 933a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed SOCIAL-REF), architectures may similarly be employed to pool, load balance, and/or otherwise increase the communicative bandwidth required by the SOCIAL-REF controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 910 may be used to engage with various communications network types 913. For example, multiple network interfaces may be employed to allow for the communication over broadcast, multicast, and/or unicast networks.

Input Output interfaces (I/O) 908 may accept, communicate, and/or connect to user input devices 911, peripheral devices 912, cryptographic processor devices 928, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x, Bluetooth, cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 911 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 912 may be connected and/or communicate to I/O and/or other facilities of the like such as network interfaces, storage interfaces, directly to the interface bus, system bus, the CPU, and/or the like. Peripheral devices may be external, internal and/or part of the SOCIAL-REF controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the SOCIAL-REF controller may be embodied as an embedded, dedicated, and/or monitor-less (i.e., headless) device, wherein access would be provided over a network interface connection.

Cryptographic units such as, but not limited to, microcontrollers, processors 926, interfaces 927, and/or devices 928 may be attached, and/or communicate with the SOCIAL-REF controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 929. However, memory is a fungible technology and resource, thus, any number of memory embodiments may be employed in lieu of or in concert with one another. It is to be understood that the SOCIAL-REF controller and/or a computer systemization may employ various forms of memory 929. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 929 will include ROM 906, RAM 905, and a storage device 914. A storage device 914 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 929 may contain a collection of program and/or database components and/or data such as, but not limited to: operating system component(s) 915 (operating system); information server component(s) 916 (information server); user interface component(s) 917 (user interface); Web browser component(s) 918 (Web browser); database(s) 919; mail server component(s) 921; mail client component(s) 922; cryptographic server component(s) 920 (cryptographic server); the SOCIAL-REF component(s) 935; and/or the like (i.e., collectively a component collection). These components may be stored and accessed from the storage devices and/or from storage devices accessible through an interface bus. Although non-conventional program components such as those in the component collection, typically, are stored in a local storage device 914, they may also be loaded and/or stored in memory such as: peripheral devices, RAM, remote storage facilities through a communications network, ROM, various forms of memory, and/or the like.

### Operating System

The operating system component 915 is an executable program component facilitating the operation of the SOCIAL-REF controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with communications networks, data, I/O, peripheral devices, program components, memory, user input devices, and/or the like. The operating system may provide communications protocols that allow the SOCIAL-REF controller to communicate with other entities through a communications network 913. Various communication protocols may be used by the SOCIAL-REF controller as a subcarrier transport mechanism for interaction, such as, but not limited to: multicast, TCP/IP, UDP, unicast, and/or the like.

### Information Server

An information server component 916 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SOCIAL-REF controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SOCIAL-REF database 919, operating systems, other program components, user interfaces, Web browsers, and/or the like.

Access to the SOCIAL-REF database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SOCIAL-REF. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the SOCIAL-REF as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 917 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 918 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the SOCIAL-REF enabled nodes. The combined application may be nugatory on systems employing standard Web browsers.

### Mail Server

A mail server component 921 is a stored program component that is executed by a CPU 903. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the SOCIAL-REF.

Access to the SOCIAL-REF mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 922 is a stored program component that is executed by a CPU 903. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 920 is a stored program component that is executed by a CPU 903, cryptographic processor 926, cryptographic processor interface 927, cryptographic processor device 928, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the SOCIAL-REF may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the SOCIAL-REF component to engage in secure transactions if so desired. The cryptographic component facilitates the secure accessing of resources on the SOCIAL-REF and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The SOCIAL-REF Database

The SOCIAL-REF database component 919 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the SOCIAL-REF database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the SOCIAL-REF database is implemented as a data-structure, the use of the SOCIAL-REF database 919 may be integrated into another component such as the SOCIAL-REF component 935. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 919 includes several tables 919a-r. A Users table 919a may include fields such as, but not limited to: user_id, ssn, dob, first_name, last_name, age, state, address_firstline, address_secondline, zipcode, devices_list, contact_info, contact_type, alt_contact_info, alt_contact_type, UserIncome, UserBankAccount, UserPreference, UserTransactionID, UserMobileID, UserSubcription, UserFollwer, UserNewsFeeds, UserPricacySetting, and/or the like. The Users table may support and/or track multiple entity accounts on an EISA. A Financial Accounts table 919b may include fields such as, but not limited to: user_id, account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Clients table 919c may include fields such as, but not limited to: user_id, client_id, client_ip, client_type, client_model, operating_system, os_version, app_installed_flag, and/or the like. A Transactions table 919d may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, billingaddress_line1, billingaddress_line2, billing_zipcode, billing_state, shipping_preferences, shippingaddress_line1, shippingaddress_line2, shipping_zipcode, shipping_state, agent_id, agent_name, agent_auth_key, and/or the like. An Issuers table 919e may include fields such as, but not limited to: issuer_id, issuer_name, issuer_address, ip_address, mac_address, auth_key, port_num, security_settings_list, and/or the like. A Batch Data table 919f may include fields such as, but not limited to: batch_id, transaction_id_list, timestamp_list, cleared_flag_list, clearance_trigger_settings, and/or the like. A Payment Ledger table 919g may include fields such as, but not limited to: request_id, timestamp, deposit_amount, batch_id, transaction_id, clear_flag, deposit_account, transaction_summary, payor_name, payor_account, and/or the like. An Analysis Requests table 919h may include fields such as, but not limited to: user_id, password, request_id, timestamp, request_details_list, time_period, time_interval, area_scope, area_resolution, spend_sector_list, client_id, client_ip, client_model, operating_system, os_version, app_installed_flag, and/or the like. A Normalized Templates table 919i may include fields such as, but not limited to: transaction_record_list, norm_flag, timestamp, transaction_cost, biller_params_list, agent_id, agent_name, agent_auth_key, agent_products_list, num_products, product_list, product_type, product_name, class_labels_list, product_quantity, unit_value, sub_total, comment, user_account_params, account_name, account_type, account_num, billing_line1, billing_line2, zipcode, state, country, phone, sign, and/or the like. A Classification Rules table 919j may include fields such as, but not limited to: rule_id, rule_name, inputs_list, operations_list, outputs_list, thresholds_list, and/or the like. A Strategy Parameters table 919k may include fields such as, but not limited to: strategy_id, strategy_params_list, regression_models_list, regression_equations_list, regression_coefficients_list, fit_goodness_list, lsm_values_list, and/or the like. A merchant table 919l includes fields such as, but not limited to: MerchantID, MerchantName, MerchantType, MerchantTerminalID, MerchantAddress, MerchantGPS, MerchantURL, MerchantTransactionID, MerchantReferralMax, and/or the like. A Message table 919m includes fields such as, but not limited to: MessageID, MessageType, MessageUserID, MessageFormat, MessageOriginatorID, MessageDestinationID, MessageHeader, MessageFieldNo, MessageFieldValue, MessageChannel, and/or the like. A Share Item table 919n includes fields such as, but not limited to: ItemID, ItemConsumerID, ItemFeedsID, ItemMerchantID, TriggreType, ItemTime, ItemContent, ItemCategory, ItemPublishing, and/or the like. A Referral Chain table 919o includes fields such as, but not limited to: UserID, UserName, 1stDegreeFollower, 2ndDegreeFollower, DegreeMax, 1stDegreeFee, 2ndDegreeFee, ItemID, ItemCategory, and/or the like. A Share Channel table 919p includes fields such as, but not limited to: ChannelID, ChannelName, ChannelType, ChannelUserID, ChannelAccountAuthentication, and/or the like. A Restriction table 919q includes fields such as, but not limited to: RuleID, RuleTitle, RuleRelatedEntity, RuleUserID, RuleInsuranceID, RuleWhiteListParameter (e.g., including subfields such as MaxAmount, MaxFrequency, etc.), RuleBlackListParameter (e.g., including subfields such as BlockedUserID, BlockedFollower, BlockedMerchantID, etc.), and/or the like. A Market Data table 919r may include fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi.

In one embodiment, user program may contain various user interface primitives, which may serve to update the SOCIAL-REF. Also, various accounts may require custom database tables depending upon the environments and the types of clients the SOCIAL-REF may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 919a-r. The SOCIAL-REF may be configured to keep track of various settings, inputs, and parameters via database controllers.

The SOCIAL-REF database may communicate to and/or with other components in a component collection, including itself, and/or facilities of the like. Most frequently, the SOCIAL-REF database communicates with the SOCIAL-REF component, other program components, and/or the like. The database may contain, retain, and provide information regarding other nodes and data.

### The SOCIAL-REFs

The SOCIAL-REF component 935 is a stored program component that is executed by a CPU. In one embodiment, the SOCIAL-REF component incorporates any and/or all combinations of the aspects of the SOCIAL-REF that was discussed in the previous figures. As such, the SOCIAL-REF affects accessing, obtaining and the provision of information, services, transactions, and/or the like across various communications networks.

The SOCIAL-REF transforms user submission of a share item and/or via SOCIAL-REF components, such as activity tracking 942, registration 943, payment verification 945, rewards calculation 946, share channel publication 947, user access control 948, and/or the like into referral fee payments.

The SOCIAL-REF component facilitates access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the SOCIAL-REF server employs a cryptographic server to encrypt and decrypt communications. The SOCIAL-REF component may communicate to and/or with other components in a component collection, including itself, and/or facilities of the like. Most frequently, the SOCIAL-REF component communicates with the SOCIAL-REF database, operating systems, other program components, and/or the like. The SOCIAL-REF may contain, communicate, generate, obtain, and/or provide program component, system, user, and/or data communications, requests, and/or responses.

### Distributed SOCIAL-REFs

The structure and/or operation of any of the SOCIAL-REF node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the SOCIAL-REF controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the SOCIAL-REF controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
          $input = “”;
          $input = socket_read($client, 1024);
          $data .= $input;
} while($input != “”);
// parse data to extract variables
$obj = json_decode($data, true);
// store input data in a database
mysql_connect(“201.408.185.132”,$DBserver,$password); // access
database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference.

In order to address various issues and advance the art, the entirety of this application for SOCIAL RETAIL REFERRAL CONTROL APPARATUSES, METHODS AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a SOCIAL-REF individual and/or enterprise user, database configuration and/or relational model, data type, data transmission and/or network framework, syntax structure, and/or the like, various embodiments of the SOCIAL-REF, may be implemented that facilitates a great deal of flexibility and customization. While various embodiments and discussions of the SOCIAL-REF have been directed to social networks, however, it is to be understood that the embodiments described herein may be readily configured and/or customized for a wide variety of other applications and/or implementations.

What is claimed is:

1. An activity tracking and sharing processor-implemented method, comprising:
receiving a share item via a share channel from a user;
determining a share target for the received share item based on share item characteristics and user specified sharing criteria;
generating a share message including the share item in accordance with the user specified sharing criteria;
distributing the share message via the share channel to the share target;
tracking the share target activity usage;
determining, a referral reward to the user based on the tracked share target activity usage; and
facilitating a payment of the determined referral reward from an associated sponsor to the user.

2. The method of claim 1, wherein the share channel is electronic mail.

3. The method of claim 1, wherein the share channel is a social media platform.

4. The method of claim 1, wherein the share target is a friend connection of the user on a social media platform.

5. The method of claim 1, wherein share item characteristics include a category the share item belongs to.

6. The method of claim 1, wherein the category comprises any of electronics, beauty, apparel, home and garden, books, and digital goods.

7. The method of claim 1, wherein the user specified sharing criteria includes a user specified interests group for a category of the share item.

8. The method of claim 7, wherein the user specified interests group is created by user submitting a selection of share target from the user's social contacts and allowing the selection of share target to view share items in the category.

9. The method of claim 7, wherein the determining a share target for the received share item further comprising:
identifying a category of the received share item and an interests group associated with the category; and
determining when the share target is in the interests group.

10. The method of claim 1, wherein the user specified sharing criteria allows a first portion of information related to the share item to be included in the generated share message.

11. The method of claim 1, wherein the user specified sharing criteria filters a second portion of information related to the share item not to be included in the generated share message.

12. The method of claim 11, wherein the second portion of information related to the share item includes private information of the user.

13. The method of claim 1, wherein the share target subscribes to the user's message.

14. The method of claim 1, wherein the share target comprises a first degree contact of the user on the share channel.

15. The method of claim 1, wherein the share target comprises a second degree contact of the user on the share channel, wherein the second degree contact is a contact of the user's first degree contact.

16. The method of claim 1, further comprising:
creating a unique share item identifier associated share item.

17. The method of claim 1, wherein the share target activity usage comprises any of: the share target's purchasing of the share item, the share target's sharing the share item to another share target, and the share target's feedback inputs of the share item.

18. The method of claim 17, further comprising:
querying the share target activity usage based on an identifier of the share item.

19. The method of claim 1, wherein the tracking the share target activity usage further comprising:
receiving an indication of share target activity related to the share item;
identifying a share item identifier;
determining a degree of separation between the share target and the user.

20. The method of claim 1, wherein the referral reward is determined based on a type of the share target activity.

21. The method of claim 1, further comprising:
query a list of users based on an identifier of the share item.

22. The method of claim 21, further comprising:
determining a referee based on the query results.

23. An activity tracking and sharing system, comprising:
means for receiving a share item via a share channel from a user;
means for determining a share target for the received share item based on share item characteristics and user specified sharing criteria;
means for generating a share message including the share item in accordance with the user specified sharing criteria;
means for distributing the share message via the share channel to the share target;
means for tracking the share target activity usage;
means for determining, a referral reward to the user based on the tracked share target activity usage; and
means for facilitating a payment of the determined referral reward from an associated sponsor to the user.

24. An activity tracking and sharing apparatus, comprising:
a memory;
a processor disposed in communication with said memory, and configured to issue a plurality of processing instructions stored in the memory, wherein the processor issues instructions to:
receive a share item via a share channel from a user;
determine a share target for the received share item based on share item characteristics and user specified sharing criteria;
generate a share message including the share item in accordance with the user specified sharing criteria;
distribute the share message via the share channel to the share target;
track the share target activity usage;
determine, a referral reward to the user based on the tracked share target activity usage; and
facilitate a payment of the determined referral reward from an associated sponsor to the user.

25. An activity tracking and sharing computer-readable non-transitory medium storing processor-issuable-and-generated instructions to:
receive a share item via a share channel from a user;
determine a share target for the received share item based on share item characteristics and user specified sharing criteria;
generate a share message including the share item in accordance with the user specified sharing criteria;
distribute the share message via the share channel to the share target;
track the share target activity usage;
determine, a referral reward to the user based on the tracked share target activity usage; and
facilitate a payment of the determined referral reward from an associated sponsor to the user.
